(19) United States
(12) Patent Application Publication
(10) Pub. No.: US 2025/0366523 A1
(43) Pub. Date: Dec. 4, 2025

(54) AEROSOL GENERATING DEVICE

(71) Applicant: KT&G CORPORATION, Daejeon (KR)

(72) Inventors: Tae Hun KIM, Yongin-si (KR); Ju Eon PARK, Seongnam-si (KR); Youn Ji SHIN, Seoul (KR); Hun II LIM, Seoul (KR); Hyung Jin JUNG, Seoul (KR)

(73) Assignee: KT&G CORPORATION, Daejeon (KR)

(21) Appl. No.: 19/090,748

(22) Filed: Mar. 26, 2025

(30) Foreign Application Priority Data
May 28, 2024 (KR) 10-2024-0069344

(51) Int. Cl. A24F 40/465; A24F 40/485; H05B 3/06

(52) U.S. Cl. CPC A24F 40/465; A24F 40/485; H05B 3/06

(57) ABSTRACT

An aerosol generating device includes a body including an insertion space in which an aerosol generating article is accommodated, a heater configured to heat the aerosol generating article accommodated in the insertion space by generating heat, a first thermal insulation unit surrounding at least a portion of the heater and configured to block heat generated from the heater from being transferred to a user, and a bracket spaced apart from the heater and supporting the first thermal insulation unit, wherein the first thermal insulation unit includes a first heat-conducting layer configured to disperse, through heat conduction, heat absorbed from the heater, and a first heat-blocking layer configured to block heat transferred to the first heat-conducting layer from being transferred to outside so that the heat transferred to the first heat-conducting layer remains in the first heat-conducting layer.

### CROSS-REFERENCE TO RELATED APPLICATION

This application is based on and claims priority under 35 U.S.C. § 119 to Korean Patent Application No. 10-2024-0069344, filed on May 28, 2024, in the Korean Intellectual Property Office, the disclosure of which is incorporated by reference herein in its entirety.

### BACKGROUND

### 1. Field

Various embodiments relate to an aerosol generating device, and more particularly, to an aerosol generating device having a thermal insulation structure.

### 2. Description of the Related Art

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, research on heating-type aerosol generating devices has been actively conducted.

An aerosol generating device using a method of generating aerosol by generating heat includes a heater for generating heat. When a temperature of the heater rises, a user holding the aerosol generating device may feel hot. A structure for thermal insulation is required around the heater in order to prevent heat generated by the heater from being transferred to the user.

### SUMMARY

Provided is an aerosol generating device in which a thermal insulation structure is disposed around a heater.

The technical problems of the present disclosure are not limited to the above-described description, and other technical problems may be clearly understood by one of ordinary skill in the art from the embodiments to be described hereinafter.

Additional aspects will be set forth in part in the description which follows and, in part, will be apparent from the description, or may be learned by practice of the presented embodiments.

According to an embodiment, an aerosol generating device may include a body including an insertion space in which an aerosol generating article is accommodated, a heater configured to heat the aerosol generating article accommodated in the insertion space by generating heat, a first thermal insulation unit surrounding at least a portion of the heater and configured to block heat generated from the heater from being transferred to a user, and a bracket spaced apart from the heater and supporting the first thermal insulation unit, wherein the first thermal insulation unit includes a first heat-conducting layer configured to disperse, through heat conduction, heat absorbed from the heater, and a first heat-blocking layer configured to block heat transferred to the first heat-conducting layer from being transferred to outside so that the heat transferred to the first heat-conducting layer remains in the first heat-conducting layer.

### BRIEF DESCRIPTION OF THE DRAWINGS

The above and other aspects, features, and advantages of certain embodiments will be more apparent from the following description taken in conjunction with the accompanying drawings, in which:

FIGS. 1A to 1C illustrate an aerosol generating device, according to various embodiments;

FIGS. 2A and 2B illustrate an aerosol generating device, according to other embodiments;

FIGS. 3A and 3B illustrate an aerosol generating device, according to other embodiments;

FIG. 4 is a cross-sectional view illustrating an aerosol generating device to which an example of a thermal insulation structure is applied, according to an embodiment;

FIG. 5 illustrates another example of a thermal insulation structure;

FIG. 6A is a perspective view illustrating an aerosol generating device, according to an embodiment;

FIG. 6B is an exploded cross-sectional view illustrating the aerosol generating device taken along line A-A′ in FIG. 6A, according to an embodiment;

FIG. 6C is a coupled cross-sectional view illustrating the aerosol generating device of FIG. 6B;

FIG. 7A is a perspective view illustrating an aerosol generating device, according to another embodiment;

FIG. 7B is an exploded cross-sectional view illustrating the aerosol generating device taken along line B-B′ in FIG. 7A, according to another embodiment;

FIG. 7C is a coupled cross-sectional view illustrating the aerosol generating device of FIG. 7B;

FIG. 8A is a perspective view illustrating an aerosol generating device, according to another embodiment;

FIG. 8B is an exploded cross-sectional view illustrating the aerosol generating device taken along line C-C′ in FIG. 8A, according to another embodiment;

FIG. 8C is a coupled cross-sectional view illustrating the aerosol generating device of FIG. 8B; and

FIG. 9 is a block diagram illustrating an aerosol generating device, according to another embodiment.

### DETAILED DESCRIPTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In the description of embodiments of the disclosure, certain detailed explanations of the related art are omitted when it is deemed that they may unnecessarily obscure the essences of embodiments of the disclosure. In addition, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

While such terms as “first”, “second”, etc., may be used to describe various components, such components must not be limited to the above terms. The above terms are used only to distinguish one component from another.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

An expression used in the singular encompasses the expression of the plural, unless it has a clearly different meaning in the context.

Hereinafter, the disclosure will now be described more fully with reference to the accompanying drawings, in which exemplary embodiments of the disclosure are shown such that one of ordinary skill in the art may easily work the disclosure. For the description with reference to the drawings, the same or equivalent components will be provided with the same reference numbers, and description thereof will not be repeated.

The disclosure may be implemented in a form that may be implemented by aerosol generating devices according to various embodiments described above or may be implemented in a variety of different forms and is not limited to the embodiments described herein.

Hereinafter, embodiments of the disclosure will be described in detail with reference to the drawings.

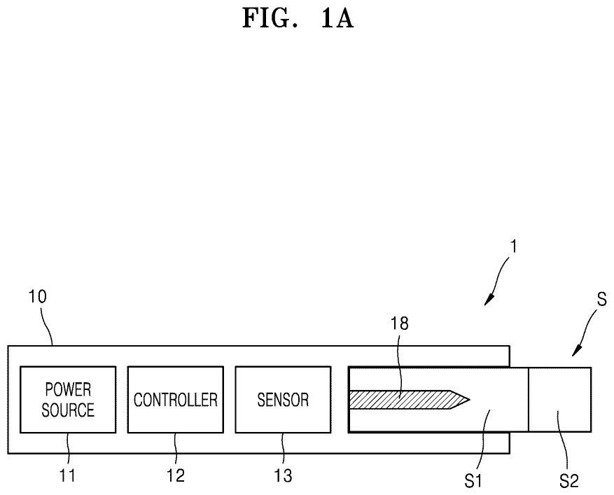

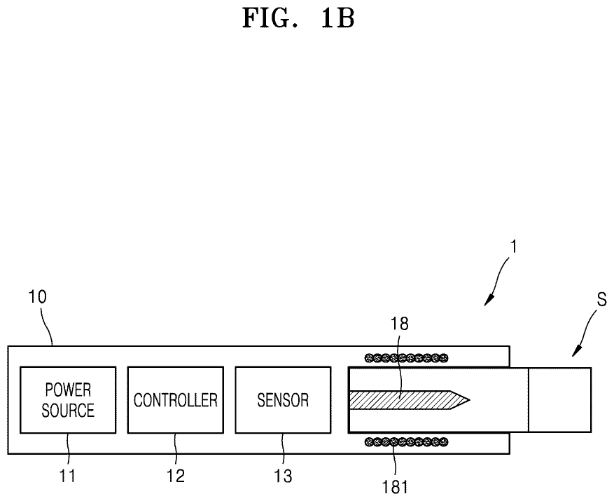

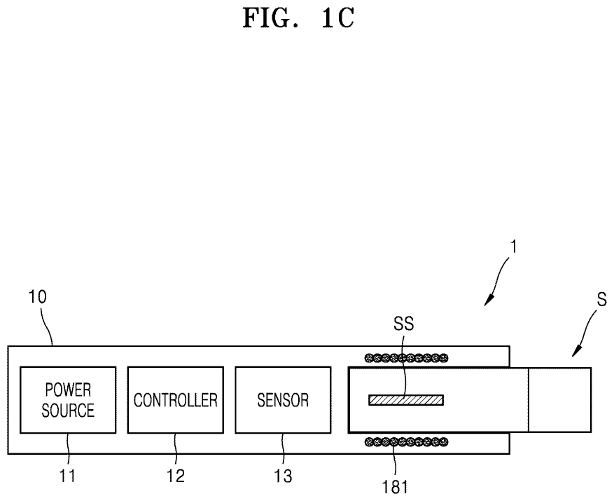

FIGS. 1A to 1C illustrate an aerosol generating device, according to various embodiments.

Referring to FIG. 1A, an aerosol generating device 1 according to embodiments may include at least one of a power source 11, a controller 12, a sensor 13, and a heater 18. At least one of the power source 11, the controller 12, the sensor 13, and the heater 18 may be disposed inside a body 10 of the aerosol generating device 1.

The body 10 may provide a space that is open upward so that a stick S, which is an aerosol generating article, is inserted. The space that is open upward may be referred to as an insertion space. The insertion space may be recessed by a certain depth toward the inside of the body 10 so that at least a part of the stick S is inserted into the insertion space. A depth of the insertion space may correspond to a length of a portion of the stick S in which an aerosol generating material and/or medium is included.

A lower end of the stick S may be inserted into the body 10, and an upper end of the stick S may protrude outward from the body 10. A user may inhale air while holding the upper end of the stick S exposed to the outside in his/her mouth.

The heater 18 may heat the stick S. The heater 18 may extend long upward, in the space into which the stick S is inserted. For example, the heater 18 may include a tube-type heating element, a plate-type heating element, a needle-type heating element, or a rod-type heating element. The heater 18 may be inserted into a lower portion of the stick S. The heater 18 may include an electro-resistive heater and/or an induction heater.

For example, referring to FIG. 1A, the heater 18 may be a resistive heater. For example, an electrically conductive track may be included in the heater 18, and the heater 18 may be heated as current flows through the electrically conductive track. The heater 18 may be electrically connected to the power source 11. The heater 18 may directly generate heat by receiving current from the power source 11.

For example, the heater 18 may be a multi-heater. The heater 18 may include a first heater and a second heater. The first and second heaters may be arranged side by side along a longitudinal direction. The first and second heaters may be heated sequentially or simultaneously.

For example, referring to FIG. 1B, the aerosol generating device 1 may include an induction coil 181 surrounding the heater 18. The induction coil 181 may cause the heater 18 to generate heat. The heater 18 is a susceptor and may generate heat due to a magnetic field generated by alternating current (AC) current flowing through the induction coil 181. The magnetic field may pass through the heater 18 to generate eddy current in the heater 18. The current may cause the heater 18 to generate heat.

For example, referring to FIG. 1C, a susceptor SS may be included inside the stick S, and the susceptor SS inside the stick S may generate heat due to a magnetic field generated by AC current flowing through the induction coil 181. The susceptor SS may be disposed inside the stick S and may not be electrically connected to the aerosol generating device 1. The susceptor SS may be inserted into the insertion space together with the stick S and may be separated from the insertion space together with the stick S. The stick S may be heated by the susceptor S inside the stick S. In this case, the heater 18 may not be provided in the aerosol generating device 1.

The power source 11 may supply power so that components of the aerosol generating device 1 operate. The power source 11 may be referred to as a battery. The power source 11 may supply power to at least one of the controller 12, the sensor 13, and the heater 18. When the aerosol generating device 1 includes the induction coil 181, the power source 11 may supply power to the induction coil 181.

The controller 12 may control an overall operation of the aerosol generating device 1. The controller may be mounted on a printed circuit board (PCB). The controller 12 may control an operation of at least one of the power source 11, the sensor 13, and the heater 18. The controller 12 may control an operation of the induction coil 181. The controller 12 may control operations of a display, a motor, etc. provided in the aerosol generating device 1. The controller 12 may check a state of each component of the aerosol generating device 1 to determine whether the aerosol generating device 1 is operable.

The controller 12 may analyze a result detected by the sensor 13 and may control processes to be performed later. For example, the controller 12 may control power supplied to the heater 18 so that an operation of the heater 18 starts or ends, based on the result detected by the sensor 13. For example, the controller 12 may control the amount or time of power supplied to the heater 18 so that the heater 18 is heated to a certain temperature or is maintained at an appropriate temperature, based on the result detected by the sensor 13.

The sensor 13 may include at least one of a temperature sensor, a puff sensor, an insertion detection sensor, and an acceleration sensor. For example, the sensor 13 may sense at least one of a temperature of the heater 18, a temperature of the power source 11, and a temperature inside and outside the body 10. For example, the sensor 13 may sense the user's puff. For example, the sensor 13 may sense whether the stick S is inserted into the insertion space. For example, the sensor 13 may sense a movement of the aerosol generating device 1.

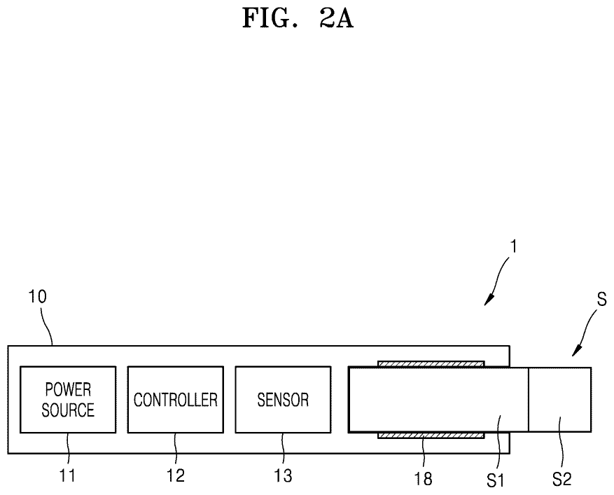

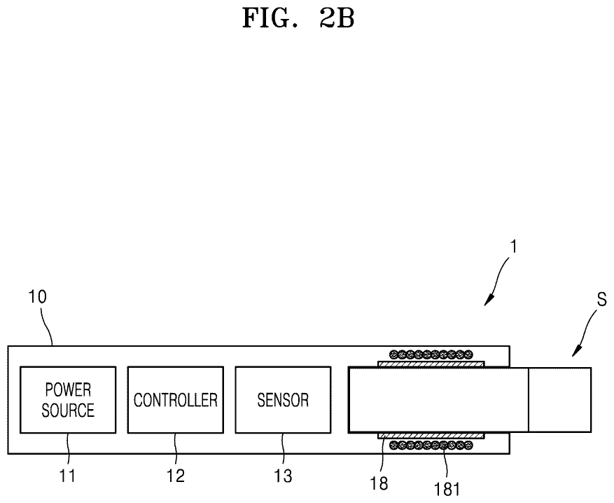

FIGS. 2A and 2B illustrate an aerosol generating device, according to other embodiments.

At least one of components of the aerosol generating device 1 of FIGS. 2A and 2B may be the same as or similar to at least one of components of the aerosol generating device 1 of FIGS. 1A to 1C, and thus, a repeated description will be omitted.

Referring to FIG. 2A, the heater 18 may extend long upward around a space into which the stick S is inserted. For example, the heater 18 may have a tube shape including a hollow portion therein. The heater 18 may be disposed around the insertion space. The heater 18 may surround at least a part of the insertion space. The heater 18 may heat the insertion space or the outside of the stick S inserted into the insertion space. The heater 18 may include an electro-resistive heater and/or an induction heater.

Referring to FIG. 2B, the aerosol generating device 1 may include the induction coil 181 surrounding the heater 18. The induction coil 181 is the same as that described above, and thus, a repeated description thereof will be omitted.

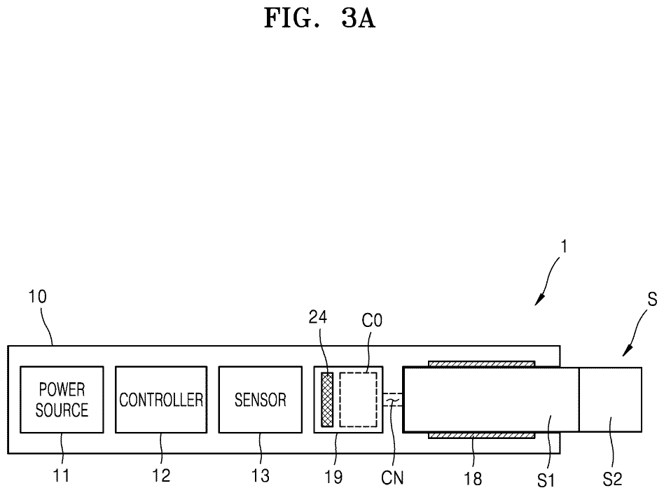

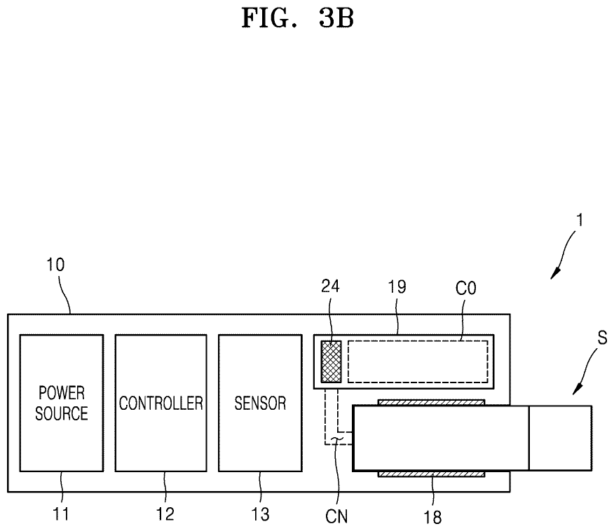

FIGS. 3A and 3B illustrate an aerosol generating device, according to other embodiments.

At least one of components of the aerosol generating device 1 of FIGS. 3A and 3B may be the same as or similar to at least one of components of the aerosol generating device 1 of FIGS. 1A to 1C, and thus, a repeated description will be omitted.

Referring to FIG. 3A, the aerosol generating device 1 may further include a cartridge 19.

The cartridge 19 may contain an aerosol generating material in a liquid state, a solid state, or a gel state. The aerosol generating material may include a liquid composition. For example, the liquid composition may be a liquid including a tobacco-containing material including a volatile tobacco flavor component, or a liquid including a non-tobacco material.

For example, the liquid composition may include water, solvents, ethanol, plant extracts, spices, flavorings, or vitamin mixtures. The spices may include menthol, peppermint, spearmint oil, and various fruit-flavored ingredients, but are not limited thereto. The flavorings may include ingredients capable of providing various flavors or tastes to the user. The vitamin mixtures may be a mixture of at least one of vitamin A, vitamin B, vitamin C, and vitamin E, but are not limited thereto. Also, the liquid composition may include an aerosol forming substance, such as glycerin and propylene glycol.

The cartridge 19 may be integrally formed with the body 10 or may be detachably coupled to the body 10. For example, the cartridge 19 may be mounted on the body 10 by being inserted into the body 10. However, the disclosure is not limited thereto, and the cartridge 19 may be fixed so as not to be removed by the user.

The cartridge may be mounted on the body in a state where the aerosol generating material is accommodated in the cartridge. However, the disclosure is not limited thereto, and the aerosol generating material may be injected into the cartridge in a state where the cartridge is coupled to the body.

Referring to FIG. 3A, the cartridge 19 may be integrally formed with the body 10, and may communicate with the insertion space through an airflow channel CN.

Referring to FIG. 3B, a space may be formed on one side in the body 10, and the cartridge 19 may be mounted on the body 10 when at least a part of the cartridge 19 is inserted into the space formed on one side in the body 10. The airflow channel CN may be defined by a part of the cartridge and/or a part of the body 10, and the cartridge 19 may communicate with the insertion space through the airflow channel CN.

Components of the aerosol generating device 1 of FIG. 3A are aligned. In the aerosol generating device 1 of FIG. 3B, the cartridge 19 and the heater 18 are arranged parallel to each other. However, an internal structure of the aerosol generating device 1 is not limited thereto. In other words, according to a design of the aerosol generating device 1, the arrangement of the power source 11, the controller 12, the sensor 13, the heater 18, and the cartridge 19 may be changed.

The body 10 may have a structure that external air may be introduced into the body 10 in a state where the cartridge 19 is inserted. In this case, the external air introduced into the body 10 may pass through the cartridge 19 and may flow to the user's mouth.

The cartridge 19 may include a storage CO containing an aerosol generating material and/or a heater 24 configured to heat the aerosol generating material of the storage CO. A liquid transfer means in which the aerosol generating material is impregnated (contained) may be disposed inside the storage CO. The liquid transfer means may include a wick such as cotton fiber, ceramic fiber, glass fiber, or porous fiber. An electrically conductive track of the heater 24 may have a coil structure that is wound around the liquid transfer means or a structure that contacts one side of the liquid transfer means. The heater 24 may be referred to as a cartridge heater 24.

The cartridge 19 may generate aerosol by converting a phase of the aerosol generating material inside the cartridge into a gas phase, by operating by an electrical signal or a wireless signal transmitted from the body 10. In this case, the aerosol may refer to gas in which vaporized particles generated from the aerosol generating material and air are mixed.

Aerosol may be generated as the liquid transfer means and the liquid composition absorbed by the liquid transfer means are heated by the cartridge heater 24. In this case, aerosol may also be generated by heating the stick S using the heater 18. While aerosol generated by the cartridge heater 24 and the heater 18 passes through the stick S, a tobacco material may be added to the aerosol, and the aerosol to which the tobacco material is added may be inhaled into the user's mouth through one end of the stick S.

The aerosol generating device 1 may include only the cartridge heater 24 and the heater 18 may not be provided in the body 10. In this case, while aerosol generated by the cartridge heater 24 passes through the stick S, a tobacco material may be added and the aerosol to which the tobacco material is added may be inhaled into the user's mouth.

The aerosol generating device 1 may include a cap (not shown). The cap may be detachably coupled to the body 10 to cover at least a part of the cartridge 19 coupled to the body 10. The stick S may be inserted into the body 10 through the cap.

The power source 11 may supply power to the cartridge 24 in addition to the above-described components. The controller 12 may control an operation of the cartridge 19 in addition to the above-described components. The controller 12 may control power supplied to the cartridge heater 24 so that an operation of the cartridge heater 24 and/or the heater 18 starts or ends, based on a result detected by the sensor 13. For example, the controller 12 may control the amount and time of power supplied to the cartridge heater 24 so that the cartridge heater 24 is heated to a certain temperature or is maintained at an appropriate temperature, based on the result detected by the sensor 13.

The sensor 13 may further include at least one of a color sensor, a cartridge detection sensor, and a cap detection sensor in addition to the above-described components. For example, the sensor 13 may sense a temperature of the cartridge heater 24. For example, the sensor 13 may sense a color of a part of a wrapper surrounding an outer surface of the stick S. For example, the sensor 13 may sense whether the cartridge 19 is mounted. For example, the sensor 13 may sense whether the cap is mounted.

The aerosol generating device 1 may further include general-purpose components in addition to the power source 11, the controller 12, the sensor 13, the heater 18, and the cartridge 19. For example, as described above, the aerosol generating device 1 may include a display capable of outputting visual information and/or a motor for outputting haptic information. Also, the aerosol generating device 1 may be manufactured in a structure in which external air may be introduced or internal gas may be discharged even in a state where the stick S is inserted.

Although not shown, the aerosol generating device 1 may constitute a system along with a separate cradle. For example, the cradle may be used to charge the power source 11 of the aerosol generating device 1. Alternatively, the heater 18 may be heated in a state where the cradle and the aerosol generating device 1 are coupled to each other.

The stick S may be similar to a general combustion-type cigarette. For example, the stick S may be divided into a first portion S1 including an aerosol generating material and a second portion S2 including a filter, etc.

The first portion S1 may be made of a sheet, a strands, or a tobacco cut filler obtained by finely cutting a tobacco sheet. Also, the first portion S1 may be surrounded by a thermally conductive material. For example, the thermally conductive material may be a metal foil such as an aluminum foil, but the disclosure is not limited thereto. Hereinafter, the first portion S1 may be referred to as a ‘medium portion’ or a ‘tobacco rod’.

The second portion S2 may be a cellulose acetate filter. The second portion S2 may include at least one segment. For example, the second portion S2 may include a first segment for cooling aerosol and a second segment for filtering a certain component included in the aerosol. Hereinafter, the second portion S2 may be referred to as a ‘filter rod’.

According to an embodiment, an aerosol generating material may also be included in the second portion S2 of the stick S. For example, an aerosol generating material made in the form of granules or capsules may be inserted into the second portion S2.

The first portion S1 may be entirely inserted into the aerosol generating device 1, and the second portion S2 may be exposed to the outside. Alternatively, only a part of the first portion S1 may be inserted into the aerosol generating device 1, or the entire first portion S1 and a part of the second portion S2 may be inserted. The user may inhale aerosol while holding the second portion S2 with his/her mouth. In this case, aerosol is generated when external air passes through the first portion S1, and the generated aerosol passes through the second portion S2 and is delivered to the user's mouth.

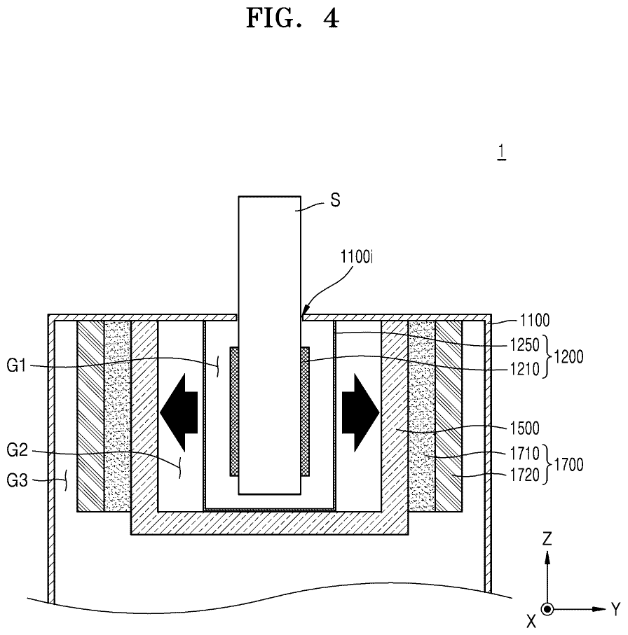

FIG. 4 is a cross-sectional view illustrating an aerosol generating device to which an example of a thermal insulation structure is applied, according to an embodiment.

Referring to FIG. 4, an aerosol generating device according to an embodiment may include a body 1100, a heater assembly 1200, a bracket 1500, and a thermal insulation unit 1700.

The body 1100 may form an overall exterior of the aerosol generating device 1, and may include an inner space in which components of the aerosol generating device 1 may be disposed. Although only an embodiment where the body 1100 has a rectangular pillar shape is illustrated in FIG. 4, a shape of the body 1100 is not limited thereto, and the body 1100 may have a cylindrical shape or a polygonal pillar shape.

The body 1100 may include an opening through which the aerosol generating article S may be inserted into the body 1100. At least a part of the aerosol generating article S may be inserted into or accommodated in the body 1100.

The body 1100 may include an insertion space 1100i in which the aerosol generating article S is accommodated. The insertion space 1100i may be formed in an upper portion of the body 1100. The insertion space 1100i may be open upward and may be connected to the opening.

The insertion space 1100i may have a cylindrical shape that vertically extends long. At least a part of the aerosol generating article S may be accommodated in the body 1100 through the opening over the insertion space 1100i. In this case, a depth of the aerosol generating article S may correspond to a length of a portion of the aerosol generating article S in which an aerosol generating material or medium is included.

The heater assembly 1200 may be located in the inner space of the body 1100, and may generate aerosol by heating the aerosol generating article S inserted into the housing through the opening.

The heater assembly 1200 may include a heater 1210 configured to generate heat as power is supplied, and a support portion and a cover 1250 around the heater 1210. Only the heater 1210 and the cover 1250 are schematically illustrated in FIG. 4

The heater 1210 is configured to generate heat to heat the aerosol generating article S accommodated in the insertion space 1100i. The heater 1210 may generate aerosol generated from the aerosol generating article S. The heater 1210 may vertically extend along the insertion space 1100i.

According to an embodiment, in an example, the heater 1210 may be a cylindrical heater 1210 surrounding at least a part of the insertion space 1100i. The heater 1210 may heat an outer circumferential surface of the aerosol generating article S accommodated in the insertion space 1100i. In this case, the heater 1210 may be an electro-resistive heater.

However, the embodiment is not limited to the shape and the arrangement of the heater 1210. In another example, the heater 1210 may be inserted into the aerosol generating article S to heat the inside of the aerosol generating article S accommodated in the insertion space 1100i.

In another example, the heater assembly 1200 may include an induction coil (not shown) that generates an induction magnetic field toward the heater 1210, and in this case, the heater 1210 may be a susceptor that generates heat due to the induction magnetic field.

At least a portion of the aerosol generating article S accommodated in the insertion space 1100i may be heated by the heater 1210, and vaporized particles generated by the heating of the aerosol generating article S and air introduced into an inner space of the body 1100 through an air inlet (e.g., the opening of the body 1100) formed in a portion of the body 1100 may be mixed to generate aerosol.

The heater 1210 may be a cartridge heater (e.g., the cartridge heater 24 of FIGS. 3A and 3B). In this case, the aerosol generating article S may not be a cigarette or a stick, but may be the cartridge 19 of FIGS. 3A and 3B.

The cover 1250 may form a portion of an exterior of the heater assembly 1200 (e.g., an outer circumferential surface of the heater assembly 1200), and may accommodate and protect components of the heater assembly 1200 therein.

The cover 1250 may include the insertion space 1100i in which the aerosol generating article S is accommodated. In this case, the insertion space 1100i may be a space surrounded by the cover 1250 and also surrounded by the heater 1210 disposed inside the cover 1250.

The cover 1250 may surround the heater 1210. The cover 1250 may be open in a longitudinal direction (e.g., a z axis direction) of the heater 1210. Accordingly, the cover 1250 may have a cylindrical shape that is open in the z axis direction.

The cover 1250 may block heat generated by the heater 1210 from being transferred to the outside. In order to increase the efficiency of thermal insulation, the cover 1250 may be spaced apart from an outer surface of the heater 1210. A space between the cover 1250 and the heater 1210 may be referred to as a first thermal insulation space G1.

The first thermal insulation space G1 may be in a vacuum state to minimize heat transfer to the outside of the aerosol generating device 1. The ‘vacuum state’ does not refer to only a state where there is no air at all, but may include a state where pressure is lower than surrounding atmospheric pressure. However, the embodiment is not limited to the vacuum state. According to an embodiment, the first thermal insulation space G1 may be filled with air.

A bracket 1500 is a component for supporting the heater assembly 1200. The bracket 1500 may block heat generated from the heater 1210 or the heater assembly 1200 from being transferred to the outside. The bracket 1500 may be formed of a plastic material that does not transfer heat well or a metal material on which a heat blocking material is coated.

In order to increase the efficiency of thermal insulation, the bracket 1500 may be spaced apart from an outer surface of the heater assembly 1200. That is, the bracket 1500 may be spaced apart from the cover 1250. When the heater assembly 1200 includes only the heater 1210, the bracket 1500 may be spaced apart from the heater 1210.

A space between the bracket 1500 and the heater assembly 1200 may be referred to as a second thermal insulation space G2. The second thermal insulation space G2 may be in a vacuum state to minimize heat transfer to the outside of the aerosol generating device 1. However, the embodiment is not limited to the vacuum state. When necessary, the second thermal insulation space G2 may be filled with air. A distance between the bracket 1500 and the heater assembly 1200 may be about 0.2 cm to about 1 cm. However, the embodiment is not limited to the range.

The thermal insulation unit 1700 surrounds at least a portion of the heater 1210 or the heater assembly 1200, and is configured to block heat generated by the heater 1210 from being transferred to the user.

The thermal insulation unit 1700 may be coupled to the bracket 1500. As shown in FIG. 4, the thermal insulation unit 1700 may be coupled to an outer surface of the bracket 1500. Accordingly, the bracket 1500 may support the thermal insulation unit 1700. However, the embodiment is not limited thereto. In another example, the thermal insulation unit 1700 may be coupled to an inner surface of the bracket 1500.

In order to increase the efficiency of thermal insulation, the thermal insulation unit 1700 may be spaced apart from an inner surface of the body 1100. A space between the thermal insulation unit 1700 and the inner surface of the body 1100 may be referred to as a third thermal insulation space G3. The third thermal insulation space G3 may be in a vacuum state to minimize heat transfer to the outside of the aerosol generating device 1. However, the embodiment is not limited to the vacuum state. When necessary, the third thermal insulation space G3 may be filled with air. A distance between the thermal insulation unit 1700 and the inner surface of the body 1100 may be about 0.1 cm to about 0.5 cm. However, the embodiment is not limited to the range.

The thermal insulation unit 1700 may include a heat-conducting layer 1710 and a heat-blocking layer 1720. The heat-conducting layer 1710 absorbs heat generated by the heater 1210 or the heater assembly 1200, and disperses the absorbed heat through heat conduction. The heat-blocking layer 1720 blocks heat generated by the heater 1210 or the heater assembly 1200.

Before describing the heat-conducting layer 1710 and the heat-blocking layer 1720 in detail, the heater 1210 may not be uniformly heated and may have a temperature difference for each portion. That is, a degree to which heat is emitted may be different for each portion of the heater 1210.

When a portion of the heater 1210 that emits a relatively large amount of heat is referred to as a ‘high-temperature portion of the heater’ and another portion of the heater 1210 that emits a relatively small amount of heat is referred to as a ‘low-temperature portion of the heater’, inside the aerosol generating device 1, a portion adjacent to the high-temperature portion of the heater 1210 will be heated hotter than a portion adjacent to the low-temperature portion of the heater 1210.

Accordingly, a specific portion inside the aerosol generating device 1 may become excessively hot. The specific portion that becomes excessively hot may be referred to as a hot spot. That is, a hot spot may occur inside the aerosol generating device 1. The hot spot may cause a failure of components or parts inside the device.

The hot spot may also affect the outside of the body 1100. In detail, the hot spot may emit more heat than other portions. Accordingly, a general thermal insulation structure has a limit to blocking all heat emitted from the hot spot. Heat that is not blocked inside the aerosol generating device 1 may be released to the outside of the device to make a portion of the body 1100 adjacent to the hot spot hot. Accordingly, the user may feel that a specific portion of the body 1100 is excessively hot. Also, as time passes and the heat spreads along the body 1100, a temperature of the outside of the body 1100 may eventually rise.

In order to prevent this phenomenon, it is necessary to block heat from being released to the outside of the body 100 and to evenly disperse heat inside the aerosol generating device 1 to prevent the occurrence of a hot spot.

The heat-conducting layer 1710 may absorb heat generated by the heater 1210 or the heater assembly 1200, and may spread the heat to a whole surface of the heat-conducting layer 1710 through heat conduction. That is, heat absorbed by the heat-conducting layer 1710 may be conducted over the whole surface of the heat-conducting layer 1710 along the heat-conducting layer 1710. As a result, heat may be dispersed over a wide area inside the aerosol generating device 1.

Because the heat-conducting layer 1710 surrounds the heater 1210 or the heater assembly 1200, a portion of the heat-conducting layer 1710 may be adjacent to the high-temperature portion of the heater 1210, and another portion of the heat-conducting layer 1710 may be adjacent to the low-temperature portion of the heater 1210. That is, when the heat-conducting layer 1710 absorbs heat from the heater 1210, the heat-conducting layer 1710 may unevenly absorb heat throughout the heat-conducting layer 1710. Accordingly, a portion of the heat-conducting layer 1710 may have a relatively high temperature, and another portion of the heat-conducting layer 1710 may have a relatively low temperature.

However, because heat moves from a high-temperature portion to a low-temperature portion and is dispersed throughout the heat-conducting layer 1710 according to heat conduction characteristics, heat emitted from the heat-conducting layer 1710 may be uniformly released throughout the entire area of the heat-conducting layer 1710.

The amount of heat emitted from the heater 1210 or the heater assembly 1200 is generally greater than the amount of heat emitted from the heat-conducting layer 1710. Accordingly, before heat is entirely dispersed along the heat-conducting layer 1710, the heat-conducting layer 1710 may absorb heat newly emitted from the heater assembly 1200.

In this case, at the portion of the heat-conducting layer 1710 adjacent to the high-temperature portion of the heater 1210, a speed at which heat is absorbed by the heat-conducting layer 1710 may be faster than a speed at which heat is dispersed along the heat-conducting layer 1710. Accordingly, a temperature of the portion may be higher than that of the other portion of the heat-conducting layer 1710. That is, despite the arrangement of the heat-conducting layer 1710, a hot spot may occur. In order to prevent the occurrence of a hot spot, it is necessary to secure a sufficient time for heat to be entirely dispersed along the heat-conducting layer 1710.

In order to secure a sufficient time for the heat-conducting layer 1710 to evenly distribute heat, the heat-blocking layer 1720 may be disposed. The heat-blocking layer 1720 may face the heat-conducting layer 1710 and may be adjacent to the heat-conducting layer 1710. In detail, the heat-blocking layer 1720 may be in contact with the heat-conducting layer 1710.

The heat-conducting layer 1710 and the heat-blocking layer 1720 may be sequentially arranged in a direction from the inside to the outside of the body 1100, That is, the heat-blocking layer 1720 may be disposed closer to the outside of the body 1100 than the heat-conducting layer 1710, and the heat-conducting layer 1710 may be disposed closer to the inside of the body 1100 than the heat-blocking layer 1720.

The heat-blocking layer 1720 may block heat emitted from the heat-conducting layer 1710 from being transferred to the outside. In detail, the heat-blocking layer 1720 may block heat transferred from the heater 1210 or the heater assembly 1200 to the heat-conducting layer 1710 from being transferred to the outside so that the heat remains in the heat-conducting layer 1710. When the movement of heat is blocked by the heat-blocking layer 1720, the heat may be dispersed along the heat-conducting layer 1710 contacting the heat-blocking layer 1720.

Even when the heat-blocking layer 1720 does not block all heat emitted from the heat-conducting layer 1710, because heat partially blocked by the heat-blocking layer 1720 remains in the heat-conducting layer 1710, the heat may be dispersed over the whole surface of the heat-conducting layer 1710. That is, due to the presence of the heat-blocking layer 1720, the heat-conducting layer 1710 may secure a time to disperse heat over the whole surface.

In summary, the thermal insulation unit 1700 may prevent heat from escaping to the outside of the aerosol generating device 1 through the heat-blocking layer 1720. Also, even when the thermal insulation unit 1700 does not prevent some heat from escaping, the thermal insulation unit 1700 may disperse heat throughout the device through the heat-conducting layer 1710. Accordingly, the thermal insulation unit 1700 may prevent the occurrence of a hot spot. Ultimately, the body 1100 may be prevented from being heated by the hot spot.

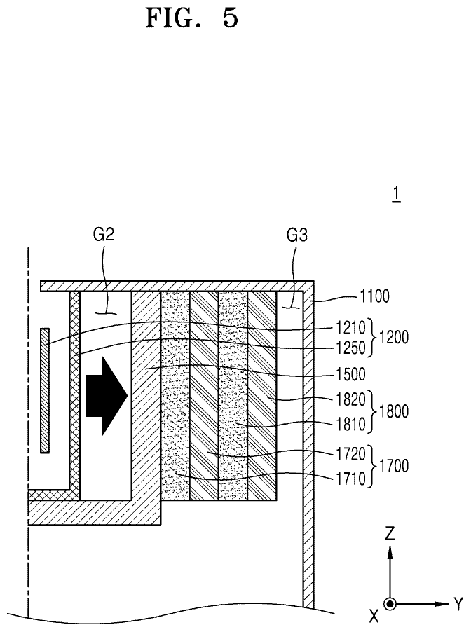

The heat-conducting layer 1710 may include various materials having high thermal conductivity. The heat-blocking layer 1720 may include various materials having excellent thermal insulation effects. As shown, each of the heat-conducting layer 1710 and the heat-blocking layer 1720 may be formed as a film or a tape. One surface of the heat-conducting layer 1710 may be attached to the outer surface of the bracket 1500, and one surface of the heat-blocking layer 1720 may be attached to the other surface of the heat-conducting layer 1710. However, a structure and a shape of each of the heat-conducting layer 1710 and the heat-blocking layer 1720 are not limited thereto. FIG. 5 illustrates another example of a thermal insulation structure.

Referring to FIG. 5, the aerosol generating device 1 according to an embodiment may include the body 1100, the heater assembly 1200, the bracket 1500, a first thermal insulation unit 1700, and a second thermal insulation unit 1800.

At least one of components of the aerosol generating device 1 of FIG. 5 may be the same as or similar to at least one of components of the aerosol generating device 1 illustrated in FIG. 4, and thus, a repeated description will be omitted.

Compared to FIG. 4, the aerosol generating device 1 of FIG. 5 may include two thermal insulation units (e.g., 1700 and 1800). The first thermal insulation unit 1700 may be coupled to the bracket 1500. The second thermal insulation unit 1800 may be coupled to the first thermal insulation unit 1700.

The second thermal insulation unit 1800 may be disposed outside the first thermal insulation unit 1700. In other words, the second thermal insulation unit 1800 may be disposed closer to the outside of the body 1100 than the first thermal insulation unit 1700.

Accordingly, a first heat-conducting layer 1710, a first heat-blocking layer 1720, a second heat-conducting layer 1810, and a second heat-blocking layer 1820 may be sequentially arranged in contact with each other in a direction from the inside to the outside of the body 1100.

Functions of the first and second heat-conducting layers 1710 and 1810 and the first and second heat-blocking layers 1720 and 1820, which are sub components of the first and second thermal insulation units 1700 and 1800, are the same as those described with reference to FIG. 4, and thus, a repeated description will be omitted.

As two thermal insulation units (e.g., 1700 and 1800) are disposed, heat that is not blocked by the first thermal insulation unit 1700 may be blocked by the second thermal insulation unit 1800. In this case, the second thermal insulation unit 1800 may block heat from being transferred to the outside, and may also disperse heat to a wide area inside the aerosol generating device 1 to prevent the occurrence of a hot spot. Accordingly, heat may be evenly distributed throughout the aerosol generating device 1, thereby further increasing the effect of thermal insulation.

In order to increase the efficiency of thermal insulation, the heater assembly 1200 and the bracket 1500 may be spaced apart from each other to form the second thermal insulation space G2, and the second thermal insulation unit 1800 and an inner surface of the body 1100 may be spaced apart from each other to form the third thermal insulation space G3. The second thermal insulation space G2 and the third thermal insulation space G3 are the same as those described with reference to FIG. 4, and thus, a repeated description will be omitted.

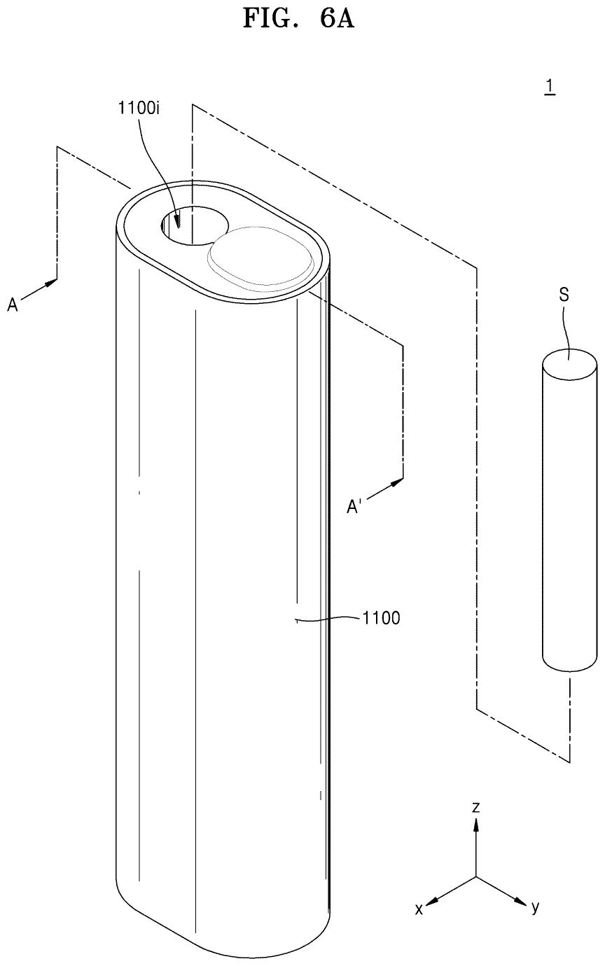

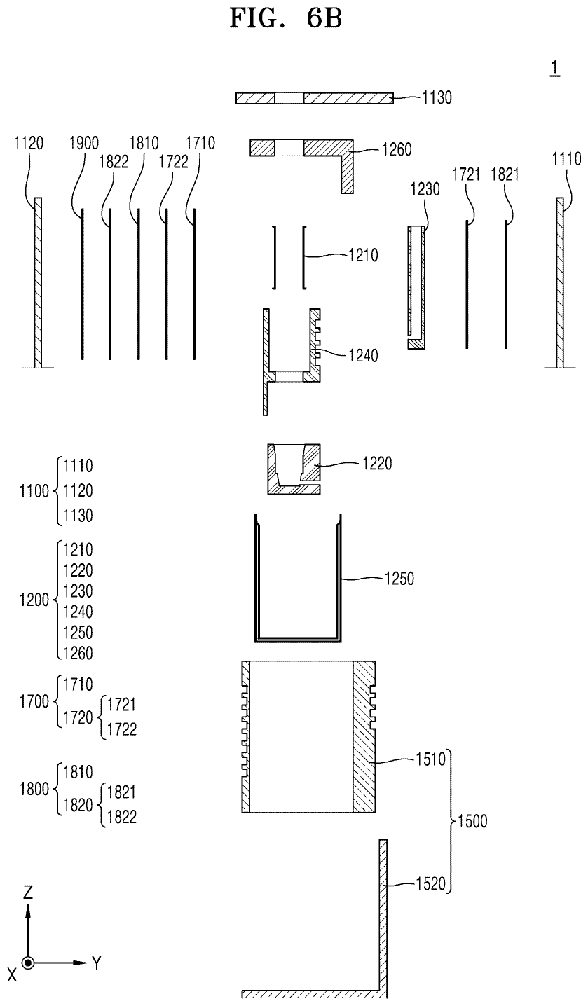

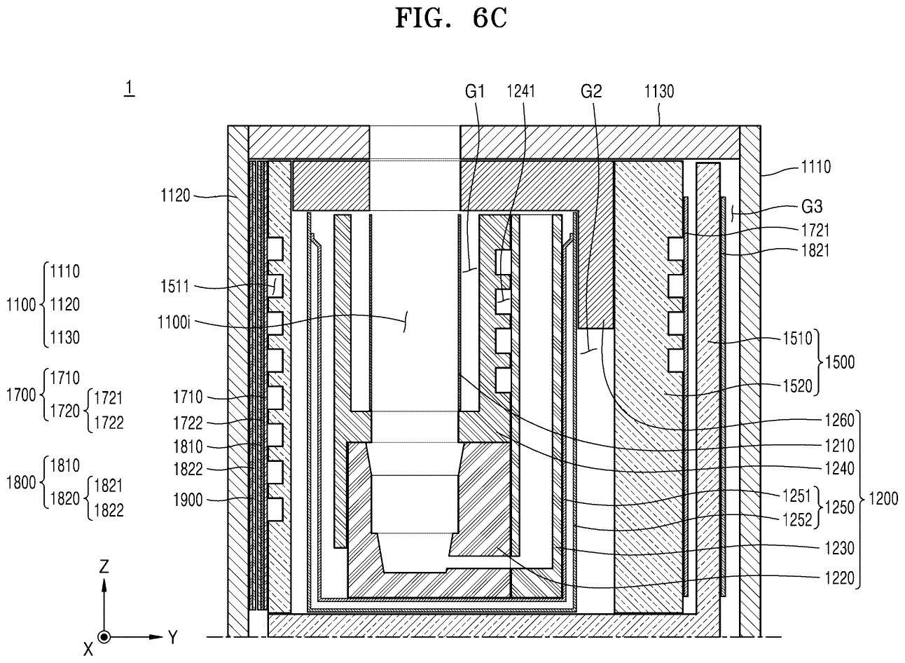

FIG. 6A is a perspective view illustrating an aerosol generating device, according to an embodiment. FIG. 6B is an exploded perspective view illustrating the aerosol generating device taken along line A-A′ in FIG. 6A, according to an embodiment.

FIG. 6C is a coupled cross-sectional view illustrating the aerosol generating device of FIG. 6B.

Referring to FIGS. 6A to 6C, the aerosol generating device 1 according to an embodiment may include the body 110, the heater assembly 1200, the bracket 1500, the first thermal insulation unit 1700, the second thermal insulation unit 1800, and a third thermal insulation unit 1900.

At least one of components of the aerosol generating device 1 of FIGS. 6A to 6C may be the same as or similar to at least one of components of the aerosol generating device 1 of FIG. 4, and thus, a repeated description will be omitted.

The body 1100 may be separated into a rear housing 1110, a front housing 1120, and an upper housing 1130. Internal components of the body 1100 may be located between the rear housing 1110 and the front housing 1120.

In a process of manufacturing the aerosol generating device 1, the internal components of the body 1100 may be coupled to each other, and then the rear housing 1110, the front housing 1120, and the upper housing 1130 may be coupled in a finishing step. In this case, the rear housing 1110 and the front housing 1120 may be coupled to each other by approaching each other in a direction (e.g., a y axis direction) crossing a longitudinal direction of the body 1100.

Although not shown, the rear housing 1110 may cover a wider area in a circumferential direction of the body 1100 than the front housing 1120. However, shapes of the rear housing 1110 and the front housing 1120 are not limited thereto.

The heater assembly 1200 may include the heater 1210, an end support portion 1220, an airflow passage portion 1230, an inner cover 1240, an outer cover 1250, and an upper end coupling portion 1260. The heater 1210 is the same as that described above, and thus, a repeated description will be omitted.

The end support portion 1220 may be disposed under the heater 1210 and may support a lower end of the aerosol generating article S inserted into the insertion space 1100i. Although not shown, a sensor may be disposed around the end support portion 1220. According to an embodiment, the end support portion 1220 may support one end (e.g., lower portion) of the heater 1210.

The end support portion 1220 may include an inlet that is open on a side. For example, the inlet may be open toward a +y direction. The end support portion 1220 may include an outlet that is open upward. For example, the outlet may be open toward a +z direction. A passage from the inlet to the outlet may be formed inside the end support portion 1220. Air may flow through the passage.

Air may be introduced into the end support portion 1220 through the inlet. Air escaping the end support portion 1220 through the outlet may be introduced into the heater 1210. When the aerosol generating article S is inserted into the heater 1210, air escaping the end support portion 1220 may be introduced into one end of the aerosol generating article S.

The airflow passage portion 1230 provides a passage through which air passes. When air is introduced into the aerosol generating device 1 from the outside, the air may be introduced into the airflow passage portion 1230, and the air moving along the airflow passage portion 1230 may be introduced into the end support portion 1220 through the inlet of the end support portion 1220.

The airflow passage portion 1230 may face the heater 1210 and the end support portion 1220. The airflow passage portion 1230 may be disposed parallel to the heater 1210. A direction in which the airflow passage portion 1230 extends may be the same as the longitudinal direction of the heater 1210 and the z axis direction.

The airflow passage portion 1230, the end support portion 1220, and the insertion space 1100i inside the heater 1210 may be fluidly connected to each other. The expression ‘fluidly connected’ may mean that elements are connected so that a fluid such as air passes through and flows. While air passes through the airflow passage portion 1230 and the end support portion 1220 and moves into the insertion space 1100i inside the heater 1210, the air may move in a ‘U’ shape inside the heater assembly 1200.

Although not shown, a separate sensor may be attached to the airflow passage portion 1230. In this case, the sensor may be disposed inside a sensor housing and may be protected by the sensor housing.

Two covers (e.g., 1240 and 1250) may be disposed in the heater assembly 1200 of the aerosol generating device 1 according to an embodiment. In this case, the first cover 1240 may have the same meaning as the inner cover 1240, and the second cover 1250 may have the same meaning as the outer cover 1250. The expressions ‘first’ and ‘second’ are used because two covers (e.g., 1240 and 1250) are arranged, and when one cover is disposed according to an embodiment, the first cover may refer to that one cover.

The inner cover 1240 surrounds the heater 1210 at a certain distance from an outer surface of the heater 1210, and accommodates at least a portion of the heater 1210 therein. The heater 1210 may be primarily protected by the inner cover 1240.

The inner cover 1240 may support one end (e.g., lower portion) of the heater 1210. According to an embodiment, the inner cover 1240 may support one end of the heater 1210 together with the end support portion 1220.

A portion of the inner cover 1240 may extend in the longitudinal direction (e.g., the z axis direction) of the heater 1210 and may surround a portion of the end support portion 1220 disposed under the heater 1210. In this case, the inlet may be disposed in the other portion of the end support portion 1220 not covered by the inner cover 1240. The airflow passage portion 1230 may be coupled to the other portion of the end support portion 1220. The inner cover 1240 may be located between the heater 1210 and the airflow passage portion 1230. In this case, a side portion of the airflow passage portion 1230 may be supported by the inner cover 1240.

A space between the inner cover 1240 and the heater 1210 may correspond to the first thermal insulation space G1. Also, in order to increase the efficiency of thermal insulation, the inner cover 1240 may include one or more grooves 1241 in an outer surface of the inner cover 1240. The inside of the groove 1241 may be in a vacuum state or may be filled with air.

Although at least a portion of the inner cover 1240 contacts the airflow passage portion 1230, because grooves for thermal insulation exist between portions contacting the airflow passage portion 1230, heat may be relatively slowly transferred from the inner cover 1240 to the airflow passage portion 1230. Also, when grooves are disposed at a portion where two components contact each other, a contact area between the two components may be reduced. Accordingly, heat transfer from one component (e.g., the inner cover 1240) to another component (e.g., the airflow passage portion 1230) through heat conduction may be minimized.

The outer cover 1250 may form a portion of an exterior of the heater assembly 1200 (e.g., an outer circumferential surface of the heater assembly 1200), and may accommodate and protect components of the heater assembly 1200 therein. For example, the heater 1210, the end support portion 1220, the airflow passage portion 1230, and the inner cover 1240 may be accommodated in the outer cover 1250. Accordingly, the heater 1210 may be secondarily protected by the outer cover 1250.

The outer cover 1250 may support the end support portion 1220 and a lower end of the inner cover 1240. The outer cover 1250 may support the side portion of the airflow passage portion 1230. The airflow passage portion 1230 may be disposed between the inner cover 1240 and the outer cover 1250 and may be supported by at least one of the inner cover 1240 and the outer cover 1250.

That is, the airflow passage portion 1230 may be disposed on an outer surface of the inner cover 1240 and may be supported by the inner cover 1240, or may be disposed on an inner surface of the outer cover 1250 and may be supported by the outer cover 1250. In this case, because the inside of the airflow passage portion 1230 is an empty space through which air passes, the airflow passage portion 1230 may function as a thermal insulation space.

The outer cover 1250 may surround the inner cover 1240 and may be spaced apart from the outer surface of the inner cover 1240. A space between the inner cover 1240 and the outer cover 1250 may function as a thermal insulation space. The outer cover 1250 may be spaced apart from the bracket 1500. A space between the outer cover 1250 and the bracket 1500 may correspond to the second thermal insulation space G2.

The outer cover 1250 may block heat generated by the heater 1210 from being transferred to the outside. In order to increase the efficiency of thermal insulation, the outer cover 1250 may include a double-wall structure. In detail, the outer cover 1250 may include an inner wall 1251 facing the inner cover 1240 and an outer wall 1252 at least partially spaced apart from the inner wall 1251. A space between the inner wall 1251 and the outer wall 1252 may function as a thermal insulation space.

The upper end coupling portion 1260 may be disposed over the heater 1210 and may form a portion of an exterior of the heater assembly 1200 (e.g., an upper wall of the heater assembly 1200). The upper end coupling portion 1260 may be disposed under the upper housing 1130.

A portion of the upper end coupling portion 1260 may be coupled to the heater 1210 and the inner cover 1240. In detail, a portion of the upper end coupling portion 1260 may be coupled to an open end of the inner cover 1240 and the heater 1210. One portion of the upper end coupling portion 1260 may be open toward the outside of the aerosol generating device 1 so that the aerosol generating article passes through and is accommodated in the insertion space.

Another portion of the upper end coupling portion 1260 may be located over the airflow passage portion 1230. Although not shown, the other portion of the upper end coupling portion 1260 may be open toward the upper side of the aerosol generating device 1 so that air is introduced into the airflow passage portion 1230.

As a result, the one portion and the other portion of the upper end coupling portion 1260 may be coupled to an open end of the outer cover 1250. The upper end coupling portion 1260 may partially close the open end of the outer cover 1250.

Still another portion of the upper end coupling portion 1260 may extend between the outer cover 1250 and the bracket 1500. The still other portion of the upper end coupling portion 1260 may be engaged between the outer cover 1250 and the bracket 1500 and may be supported by the outer cover 1250 and the bracket 1500. In this case, the upper end coupling portion 1260 may close the second thermal insulation space G2.

The bracket 1500 may be separated into a first member 1510 and a second member 1520. In detail, the first member 1510 may have a cylindrical shape surrounding the heater 1210 or the heater assembly 1200. The second member 1520 is coupled to a side portion of the first member 1510 and one end of the first member 1510 to block an open end of the first member 1510.

The first member 1510 of the bracket 1500 may be spaced apart from the outer cover 1250. A space between the first member 1510 and the outer cover 1250 may correspond to the second thermal insulation space G2.

Also, in order to increase the efficiency of thermal insulation, the first member 1510 may include one or more grooves 1511 in an outer surface of the first member 1510. The inside of the groove 1511 may be in a vacuum state or may be filled with air.

Although the first member 1510 contacts the first thermal insulation unit 1700 through several portions, because grooves for thermal insulation exist between contact portions, heat may be relatively slowly transferred from the first member 1510 to the first thermal insulation unit 1700. Also, when grooves are disposed at a portion where two components contact each other, a contact area between the two components may be reduced. Accordingly, heat transfer from one component (e.g., the first member 1510) to another component (e.g., the first thermal insulation unit 1700) through heat conduction may be minimized.

The second member 1520 of the bracket 1500 may function as a bottom wall of the bracket 1500. The second member 1520 functioning as a bottom wall may be engaged with a lower end of the first member 1510 and may support a lower end of the outer cover 1250. One portion of the second member 1520 may extend between the first member 1510 and the rear housing 1110. The one portion of the second member 1520 may be coupled to a side portion of the first member 1510.

The first thermal insulation unit 1700 and the second thermal insulation unit 1800 may be sequentially coupled to an outer surface of the bracket 1500. In this case, the first and second thermal insulation units 1700 and 1800 disposed close to the rear housing 1110 and the first and second thermal insulation units 1700 and 1800 disposed close to the front housing 1120 are different from each other.

First, the first and second heat-blocking layers 1720 and 1820 may include first areas 1721 and 1821 and second areas 1722 and 1822 separated from each other and facing each other. The first and second heat-blocking layers 1720 and 1820 disposed close to the rear housing 1110 may be referred to as the first areas 1721 and 1821, and the first and second heat-blocking layers 1720 and 1820 disposed close to the front housing 1120 may be referred to as the second areas 1722 and 1822.

Regarding the first and second thermal insulation layers 1700 and 1800 disposed close to the front housing 1120, the first and second heat-conducting layers 1710 and 1810 may be disposed inside the second areas 1722 and 1822 of the heat-blocking layers. Accordingly, the first heat-conducting layer 1710, the second area 1722 of the first heat-blocking layer, the second heat-conducting layer 1810, and the second area 1822 of the second heat-blocking layer may be sequentially arranged in a direction from the inside to the outside of the front housing 1120. This is the same as the structure described with reference to FIG. 5.

Regarding the first and second thermal insulation units 1700 and 1800 disposed close to the rear housing 1110, a separate heat-conducting layer is not disposed. Also, the first area 1721 of the first heat-blocking layer and the first area 1821 of the second heat-blocking layer are sequentially arranged in a direction from the inside to the outside of the rear housing 1110, but do not contact each other.

The first area 1721 of the first heat-blocking layer may be disposed between an outer surface of the first member 1510 of the bracket 1500 and an inner surface of the second member 1520 and may be supported by the first member 1510. The first area 1821 of the second heat-blocking layer may be disposed on an outer surface of the second member 1520 of the bracket 1500 and may be supported by the second member 1520. That is, the first area 1721 of the first heat-blocking layer and the first area 1821 of the second heat-blocking layer may be respectively disposed inside and outside the second member 1520 with the second member 1520 of the bracket 1500 therebetween, and may not be disposed adjacent to each other.

This difference is because a distance from the heater 1210 to the rear housing 1110 is longer than a distance from the heater 1210 to the front housing 1120. Accordingly, because more components are disposed between the heater 1210 and the rear housing 1110 than between the heater 1210 and the front housing 1120, heat may be absorbed by many components as it moves. The user may feel that the rear housing 1110 is less hot than the front housing 1120.

That is, a portion close to the rear housing 1110 may have a lower importance of thermal insulation than a portion close to the front housing 1120. A portion close to the rear housing 1110 may obtain a sufficient thermal insulation effect with only a heat-blocking layer even when a heat-conducting layer is not disposed. Also, because a heat-conducting layer is not disposed, heat-blocking layers do not need to contact each other.

Meanwhile, the first area 1821 of the second heat-blocking layer of the second thermal insulation unit 1800 may be spaced apart from the rear housing 1110. A space between the first area 1821 of the second heat-blocking layer and the rear housing 1110 may correspond to the third thermal insulation space G3.

Positions of the first thermal insulation unit 1700 and the second thermal insulation unit 1800 are not limited thereto. Although not shown, for example, the first thermal insulation unit 1700 may be coupled to an inner surface of the bracket 1500. In detail, the first thermal insulation unit 1700 may be coupled to an inner surface of the first member 1510 of the bracket 1500.

In this case, the first thermal insulation unit 1700 and the second thermal insulation unit 1800 are sequentially arranged in a direction from the inside to the outside of the front housing 1120, but do not contact each other. That is, the first thermal insulation unit 1700 and the second thermal insulation unit 1800 may be disposed inside and outside the first member 1510 with the first member 1510 of the bracket 1500 therebetween, but may not be disposed adjacent to each other.

The third thermal insulation unit 1900 may be disposed outside the second thermal insulation unit 1800. As shown, the third thermal insulation unit 1900 may be disposed close to the front housing 1120, and may be disposed next to the second area 1822 of the second heat-blocking layer 1820 in a direction from the inside to the outside of the front housing 1120.

Accordingly, the first thermal insulation unit 1700, the second thermal insulation unit 1800, and the third thermal insulation unit 1900 may be sequentially arranged in contact with each other in a direction from the inside to the outside of the body 1100. The third thermal insulation unit 1900 may not be disposed close to the rear housing 1110 where the importance of thermal insulation is relatively low.

As shown, the third thermal insulation unit 1900 includes only one layer. When the third thermal insulation unit 1900 includes only one layer, the layer may correspond to a heat-blocking layer. However, the embodiment is not limited thereto, and the third thermal insulation unit 1900 may include both a heat-conducting layer and a heat-blocking layer.

Also, although the third thermal insulation unit 1900 contacts the front housing 1120, the embodiment is not limited thereto. According to an embodiment, the third thermal insulation unit 1900 may be spaced apart from the front housing 1120. In this case, a space between the third thermal insulation unit 1900 and the front housing 1120 may correspond to the third thermal insulation space G3.

According to an embodiment, the third thermal insulation unit 1900 may not be disposed. Accordingly, the second thermal insulation unit 1800 may be in contact with the front housing 1120, or may be spaced apart from the front housing 1120. When the second thermal insulation unit 1800 is spaced apart from the front housing 1120, a space between the second thermal insulation unit 1800 and the front housing 1120 may correspond to the third thermal insulation space G3.

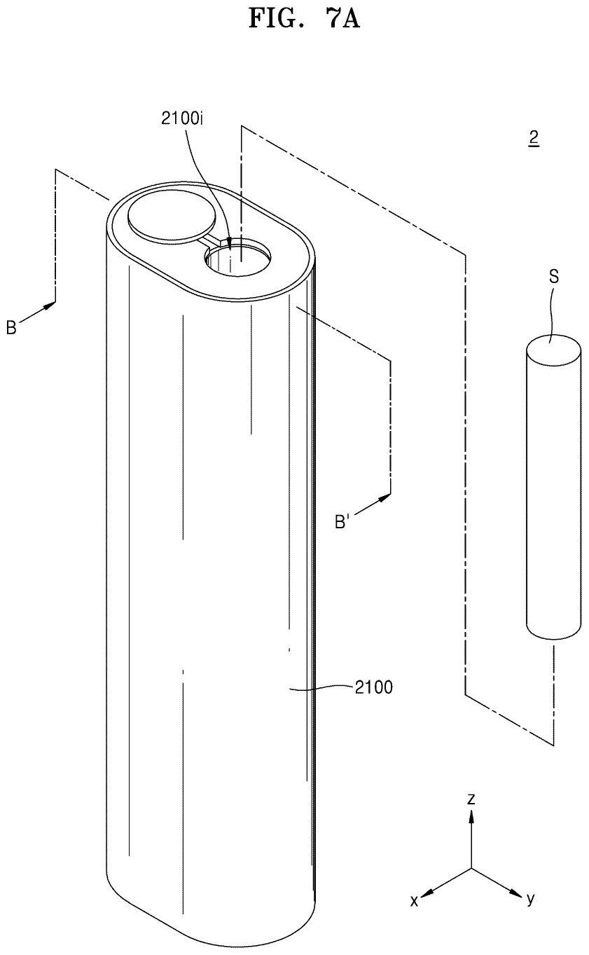

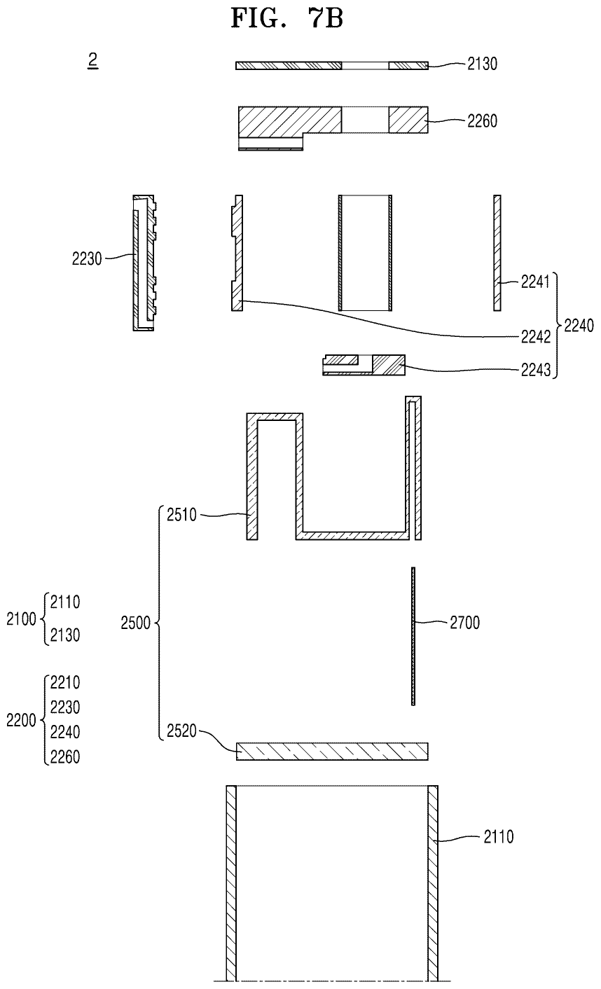

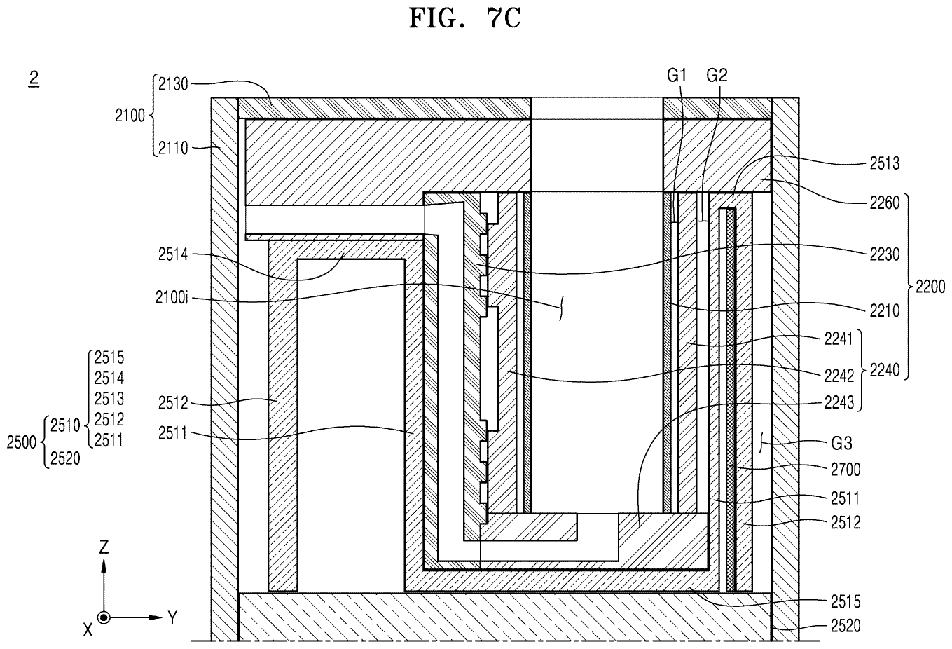

FIG. 7A is a perspective view illustrating an aerosol generating device, according to another embodiment. FIG. 7B is an exploded cross-sectional view illustrating the aerosol generating device taken along line B-B′ in FIG. 7A, according to another embodiment. FIG. 7C is a coupled cross-sectional view illustrating the aerosol generating device of FIG. 7B.

Referring to FIGS. 7A to 7C, an aerosol generating device 2 according to another embodiment may include a body 2100, a heater assembly 2200, a bracket 2500, and a thermal insulation unit 2700.

At least one of components of the aerosol generating device 2 of FIGS. 7A to 7C may be the same as or similar to at least one of components of the aerosol generating device 1 of FIG. 4, and thus, a repeated description will be omitted.

The body 2100 may be separated into a main housing 2110 and an upper housing 2130. One end of the main housing 2110 in a longitudinal direction (e.g., the z axis direction) of the main housing 2110 may be open. In a process of manufacturing the aerosol generating device 2, internal components of the body 2100 may be coupled to each other, and then may be accommodated in the main housing 2110 through the open end of the main housing 2110. As the upper housing 2130 is coupled to the main housing 2110, the assembly of the aerosol generating device 2 may be completed.

The heater assembly 2200 may include a heater 2210, an airflow passage portion 2230, a cover 2240, and an upper end coupling portion 2260. The heater 2210 is the same as that described above, and thus, a repeated description will be omitted.

The airflow passage portion 2230 may include a curved passage. In detail, the passage of the airflow passage portion 2230 may extend in a longitudinal direction (e.g., the z axis direction) of the heater 2210. Both ends of the passage may be bent to be open in a direction (e.g., the y axis direction) crossing the longitudinal direction of the heater 2210. In this case, a lower end of the passage may be open in a +y direction and may be connected to an inlet of the cover 2240, and an upper end of the passage may be open in a-y direction and may be connected to a passage formed when the upper end coupling portion 2260 and the bracket 2500 are coupled to each other.

The cover 2240 may be separated into a first portion 2241, a second portion 2242, and a third portion 2243. In a process of manufacturing the aerosol generating device 1, the first portion 2241 and the second portion 2242 may be coupled to each other by approaching each other in a direction (e.g., the y axis direction) crossing the longitudinal direction of the body 2100 with the heater 2210 therebetween. A space surrounded by the first portion 2241 and the second portion 2242 may be open in the z axis direction.

The third portion 2243 may be coupled to ends of the first portion 2241 and the second portion 2242. The third portion 2243 may close an open end of a cylindrical assembly including the first portion 2241 and the second portion 2242. As a result, the heater 2210 may be accommodated in the cover 2240 through the other open end of the cylindrical assembly.

The cover 2240 may support a lower end of the heater 2210 through the third portion 2243. Also, the cover 2240 may support a lower end of the aerosol generating article S inserted into an insertion space 2100i through the third portion 2243. Also, the cover 2240 may support the airflow passage portion 2230 through the second portion 2242.

The first portion 2241 and the second portion 2242 of the cover 2240 may surround the heater 2210 and may be spaced apart from the heater 2210. A space between the cover 2240 and the heater 2210 may correspond to the first thermal insulation space G1.

The third portion 2243 of the cover 2240 may include an inlet connected to the airflow passage portion 2230. One end of the inlet may be open toward the airflow passage portion 2230, and the other end of the inlet may be open toward the insertion space 2100i. Air moving along the airflow passage portion 2230 may be introduced into the inlet of the cover 2240. The air introduced into the cover 2240 may move to the insertion space 2100i inside the heater 2210.

The airflow passage portion 2230, the cover 2240, and the insertion space 2100i inside the heater 2210 may be fluidly connected to each other. While air passes through the airflow passage portion 2230 and the cover 2240 and moves into the insertion space 2100i inside the heater 2210, the air may move in a ‘U’ shape inside the heater assembly 2200.

The airflow passage portion 2230 may include a portion protruding toward the cover 2240. Also, the second portion 2242 of the cover 2240 may include a portion protruding toward the airflow passage portion 2230. The protruding portion of the airflow passage portion 2230 and the protruding portion of the cover 2240 may contact each other and may support each other. Because the protruding portions of the airflow passage portion 2230 and the cover 2240 contact each other, there may be an empty space between the airflow passage portion 2230 and the cover 2240. In this case, the empty space may function as a thermal insulation space.

The upper end coupling portion 2260 may be disposed over the heater 2210 and may form a portion of an exterior of the heater assembly 2200 (e.g., an upper wall of the heater assembly 2200).

A portion of the upper end coupling portion 2260 may be coupled to the heater 2210 and the cover 2240. In detail, a portion of the upper end coupling portion 2260 may be coupled to an open end of the inner cover 2240 and the heater 2210. One portion of the upper end coupling portion 2260 may be open toward the outside of the aerosol generating device 2 so that the aerosol generating article S passes through and is accommodated in the insertion space 2100i.

Another portion of the upper end coupling portion 2260 may be disposed over the bracket 2500 to support the bracket 2500. The upper end coupling portion 2260 may include a passage through which air moves. The passage of the upper end coupling portion 2260 may be disposed over the bracket 2500. The passage of the upper end coupling portion 2260 may be fluidly connected to one end of the airflow passage portion 2230 that is open in the y axis direction.

The bracket 2500 may be separated into a first member 2510 and a second member 2520. In detail, the first member 2510 has a cylindrical shape surrounding the heater 2210 or the heater assembly 2200. The second member 2520 is coupled to one end of the first member 2510 to block an open end of the first member 2510.

The first member 2510 of the bracket 2500 may include a double-wall structure. In detail, the first member 2510 may include a first extension portion 2511 surrounding the heater 2210 or the heater assembly 2200, and a second extension portion 2512 surrounding the first extension portion. Also, the first member 2510 may include a bottom portion 2515 crossing the first extension portion 2511.

The first extension portion 2511 of the first member 2510 may support a side portion of the cover 2240 and a portion of the airflow passage portion 2230 extending in the longitudinal direction of the heater 2210. The bottom portion 2515 may cross one end of the first extension portion 2511 and may function as a bottom wall of the first wall 2510. The bottom portion 2515 may support the third portion 2243 of the cover 2240.

The first member 2510 may include first and second connection portions 2513 and 2514 connecting the first extension portion 2511 to the second extension portion 2512. As shown, because the second connection portion 2514 is longer than the first connection portion 2513, a distance between two extension portions (i.e., 2511 and 2512) illustrated on a left side of FIG. 7C is greater than a distance between two extension portions (i.e., 2511 and 2512) illustrated on a right side of FIG. 7C.

In addition, because the airflow passage portion 2230 is also disposed on a left side of the heater 2210 based on the heater 2210 and a distance from the heater 2210 to the body 2100 in a left direction of the heater 2210 is greater than that in a right direction of the heater 2210, heat may be absorbed by many components while moving. That is, an empty space under the second connection portion 2514 and between the first extension portion 2511 and the second extension portion 2512 may function as a thermal insulation space. As a result, a left portion of the heater 2210 may have a lower importance of thermal insulation than a right portion.

The first member 2510 may be coupled to the upper end coupling portion 2260 through the first connection portion 2513 and the second connection portion 2514. As described above, the passage of the upper end coupling portion 2260 may be disposed over the second connection portion 2514.

A portion of the first member 2510 of the bracket 2500 may be spaced apart from the cover 2240. A space between the cover 2240 and a portion of the bracket 2500 may correspond to the second thermal insulation space G2.

The first member 2510 of the bracket 2500 may be spaced apart from the main housing 2110 of the body 2100. A space between the body 2100 and the bracket 2500 may correspond to the third thermal insulation space G3.

However, a shape of the bracket 2500 is not limited thereto. According to an embodiment, a length of the first connection portion 2513 may be the same as a length of the second connection portion 2514.

The thermal insulation unit 2700 may be disposed between the first extension proportion 2511 and the second extension portion 2512. In this case, the thermal insulation unit 2700 may be coupled to at least one of an outer surface of the first extension portion 2511 and an inner surface of the second extension portion 2512.

In this case, the thermal insulation unit 2700 may be disposed under the first connection portion 2513. Although not shown, according to an embodiment, the thermal insulation unit 2700 may also be disposed under the second connection portion 2514.

Also, according to an embodiment, the thermal insulation unit 2700 may be disposed on an outer surface of the second extension portion 2512. In this case, a space between the thermal insulation unit 2700 and the body 2100 may correspond to the third thermal insulation space G3.

A position of the thermal insulation unit 2700 is not limited thereto. Although not shown, the thermal insulation unit 2700 may be coupled to the outer surface of the second extension portion 2512. Also, the thermal insulation unit 2700 may be disposed on an outer surface of the cover 2240.

Although one thermal insulation unit 2700 is disposed inside the body 2100, the embodiment is not limited to the number of thermal insulation units 2700.

In addition, the thermal insulation unit 2700 is the same as that described above, and thus, a repeated description will be omitted.

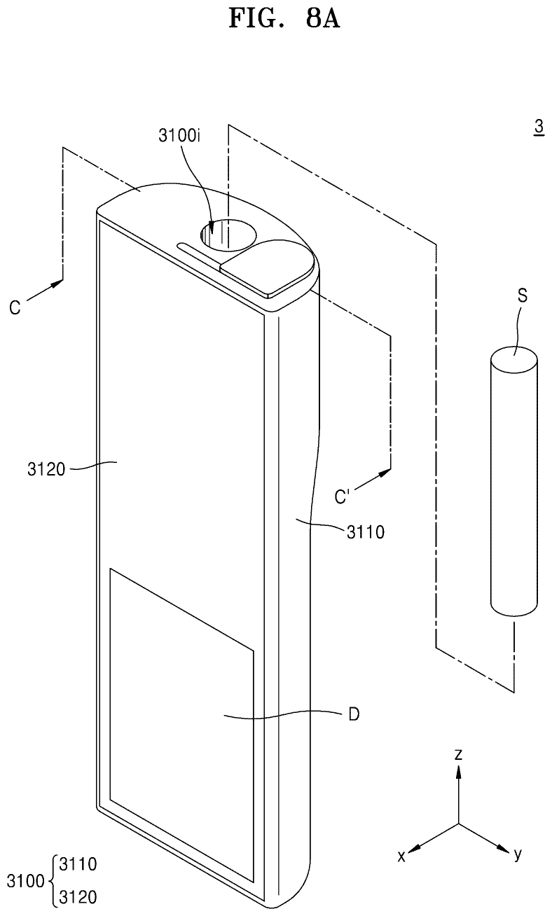

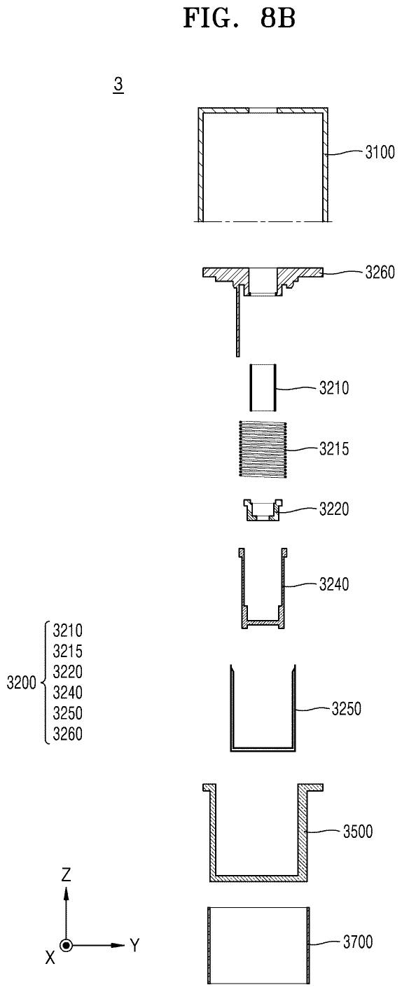

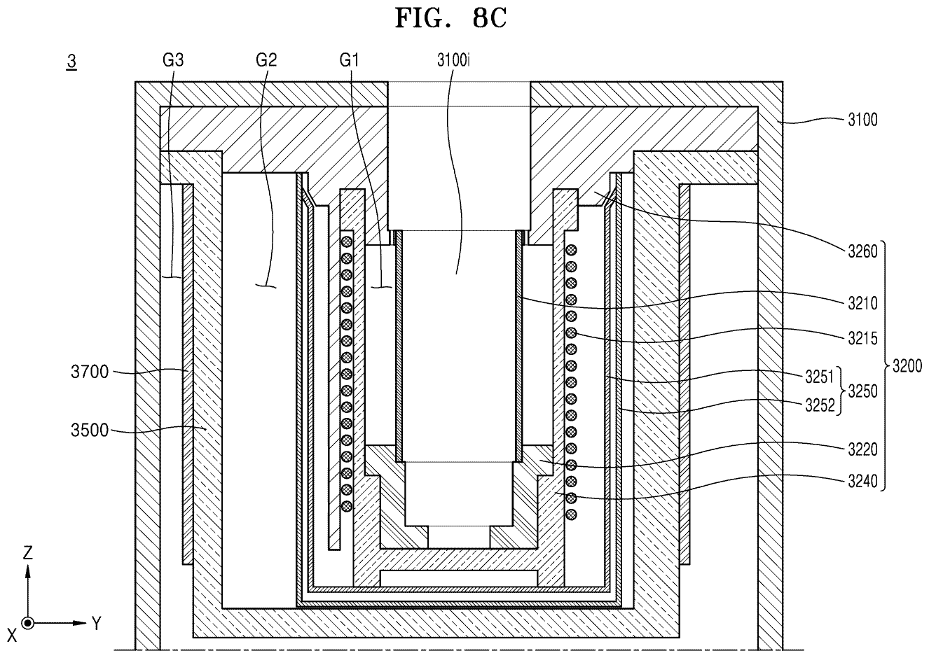

FIG. 8A is a perspective view illustrating an aerosol generating device, according to another embodiment. FIG. 8B is an exploded cross-sectional view illustrating the aerosol generating device taken along line C-C′ in FIG. 8A, according to another embodiment. FIG. 8C is a coupled cross-sectional view illustrating the aerosol generating device of FIG. 8B.

Referring to FIGS. 8A to 8C, an aerosol generating device 3 according to another embodiment may include a body 3100, a heater assembly 3200, a bracket 3500, and a thermal insulation unit 3700.

At least one of components of the aerosol generating device 3 of FIGS. 8A to 8C may be the same as or similar to at least one of components of the aerosol generating device 1 of FIG. 4, and thus, a repeated description will be omitted.

The body 3100 may be separated into a main housing 3110 and a window 3120. In this case, the window 3120 is illustrated only in the perspective view of FIG. 8A. That is, only the main housing 3110 of the body 3100 is illustrated in the cross-sectional views of FIGS. 8B and 8C. Internal components of the body 3100 may be located between the main housing 3110 and the window 3120.

In a process of manufacturing the aerosol generating device 3, the internal components of the body 3100 may be coupled to each other, and then the main housing 3110 and the window 3120 may be coupled to each other in a finishing step. In this case, the main housing 3110 and the window 3120 may be coupled to each other by approaching each other in a direction (e.g., an x axis direction) crossing a longitudinal direction of the body 3100.

The aerosol generating device 3 may further include a display D on which visual information is displayed. The display D may be disposed on the window 3120 so that at least a portion of the display D is exposed to the outside of the body 3100. The aerosol generating device 3 may provide various visual information to the user through the display D.

For example, the aerosol generating device 3 may provide information about a temperature of a heater 3210, information about whether the user's puff operation has occurred, and/or information about the number of remaining puffs of the aerosol generating article S that is inserted through the display D, but information provided through the display D may be modified in various ways.

The heater assembly 3200 may include the heater 32310, an induction coil 3215, an end support portion 3220, an inner cover 3240, an outer cover 3250, and an upper end coupling portion 3260.

The induction coil 3215 generates an induction magnetic field toward the heater 3210. In this case, the heater 3210 may be a susceptor that generates heat due to the induction magnetic field. For example, the induction coil 3215 may generate an alternating magnetic field as power is supplied, heat may be generated by the heater 3210 due to the alternating magnetic field generated by the induction coil 3215, and the aerosol generating article S inserted into an insertion space 3100i may be heated.

The induction coil 3215 may surround the inner cover 3240. That is, the induction coil 3215 may be wound around the inner cover 3240. The induction coil 3215 may be supported by the inner cover 3240.

The end support portion 3220 may be disposed on a lower end of the inner cover 3240 to support the heater 3210 and support one end of the aerosol generating article S. In this case, the end support portion 3220 may cause the end of the aerosol generating article S accommodated in the cover 3240 to be spaced apart from a bottom surface of the inner cover 3240.

When the end of the aerosol generating article S accommodated in the insertion space 3100i inside the heater 3210 contacts the end support portion 3220, the aerosol generating article S may be supported by the end support portion 3220 so as not to move in a radial direction and a longitudinal direction of the heater 3210.

In order for the aerosol generating article S to be supported by the end support portion 3220 without contacting the bottom surface of the inner cover 3240, the end support portion 3220 may include a portion protruding from an inner surface of the inner cover 3240 toward the center of the inner cover 3240. The protruding portion of the end support portion 3220 may be disposed at a lower portion of the end support portion 3220.

In order to stably support the aerosol generating article S, a plurality of protruding portions of the end support portion 3220 may be provided. Although two protruding portions are illustrated, the embodiments are not limited to the number of protruding portions of the end support portion 3220.

The plurality of protruding portions of the end support portion 3220 may be spaced apart from each other at equal intervals along the inner surface of the inner cover 3240 in a circumferential direction of the inner cover 3240. Air introduced into the inner cover 3240 may pass through an empty space between the plurality of protruding portions of the end support portion 3220 and may move to a lower portion of the end support portion 3220.

Because the end of the aerosol generating article S is spaced apart from a bottom surface of the inner cover 3240 by the end support portion 3220, the air moving to the lower portion of the end support portion 3220 may be transferred to the end of the aerosol generating article S and may be introduced into the aerosol generating article S.

The inner cover 3240 is located in an inner space of the body 3100, has a cylindrical shape, and is configured to surround and protect the heater 3210. The heater 3210 may be primarily protected by the inner cover 3240.

The inner cover 3240 may be spaced apart from the heater 3210. Accordingly, a space between the inner cover 3240 and the heater 3210 may correspond to the first thermal insulation space G1.

The inner cover 3240 may function as a passage through air introduced from the outside flows. Air may be introduced into the inner cover 3240 through an opening of the upper end coupling portion 3260 described below.

Air moving from the top to the bottom of the inner cover 3240 may be introduced into the end support portion 3220, and may reach the end of the aerosol generating article S accommodated in the insertion space 3100i.

The outer cover 3250 may form a portion of an exterior of the heater assembly 3200 (e.g., an outer circumferential surface of the heater assembly 3200), and may accommodate and protect components of the heater assembly 3200 therein. For example, the heater 3210, the end support portion 3220, and the inner cover 3240 may be accommodated in the outer cover 3250. Accordingly, the heater 3210 may be secondarily protected by the outer cover 1250.

The outer cover 3250 may support a lower end of the inner cover 3240. Also, the outer cover 3250 may be spaced apart from an outer surface of the inner cover 3240. A space between the inner cover 3240 and the outer cover 3250 may function as a thermal insulation space.

The outer cover 3250 may be spaced apart from the bracket 3500. A space between the outer cover 3250 and the bracket 3500 may correspond to the second thermal insulation space G2.

The outer cover 3250 may block heat generated by the heater 3210 from being transferred to the outside. In order to increase the efficiency of thermal insulation, the outer cover 3250 may include a double-wall structure. In detail, the outer cover 3250 may include an inner wall 3251 facing the inner cover 3240, and an outer wall 3252 at least partially spaced apart from the inner wall 3251. A space between the inner wall 3251 and the outer wall 3252 may function as a thermal insulation space.

The upper end coupling portion 3260 may be disposed over the heater 1210 and may form a portion of an exterior of the heater assembly 3200 (e.g., an upper wall of the heater assembly 3200).

A portion of the upper end coupling portion 3260 may be coupled to the heater 1210 and the inner cover 3240. In detail, a portion of the upper end coupling portion 3260 may be coupled to an open end of the inner cover 3240 and the heater 3210.

A portion of the upper end coupling portion 3260 may be open toward the outside of the aerosol generating device 1 so that the aerosol generating article passes through and is accommodated in the insertion space. In this case, air may be introduced through the open portion.

Even in a state where the aerosol generating article S is inserted into the insertion space 3100i, air may be introduced through the open portion of the upper end coupling portion 3260. In detail, the aerosol generating article S may be spaced apart from an inner surface of the open portion of the upper end coupling portion 3260. Air may move through a space formed as the aerosol generating article S is spaced apart from the upper end coupling portion 3260. That is, air may move through a space between the open portion of the upper end coupling portion 3260 and an outer circumferential surface of the aerosol generating article S.

Air moving to a lower portion of the upper end coupling portion 3260 may pass through the opening formed in the upper end coupling portion 3260. The opening may fluidly connect the open portion of the upper end coupling portion 3260 to an inner space of the inner cover 3240. Accordingly, external air may be introduced into the inner space of the inner cover 3240 through the upper end coupling portion 3260.

Although not shown, according to an embodiment, the open portion of the upper end coupling portion 3260 may include a portion protruding to support the aerosol generating article S. A plurality of protruding portions of the upper end coupling portion 3260 may be spaced apart from each other at equal intervals along the inner surface of the open portion in a circumferential direction of the open portion of the upper end coupling portion 3260. Air introduced into the upper end coupling portion 3260 may pass through an empty space between the plurality of protruding portions of the upper end coupling portion 3260 and may move to a lower portion of the upper end coupling portion 3260. That is, air may move to a space surrounded by an inner surface and the plurality of protruding portions of the upper end coupling portion 3260 and the aerosol generating article S.

A portion of the upper end coupling portion 3260 may be coupled to an open end of the bracket 3500 and the outer cover 3250. The upper end coupling portion 3260 may close the open end of the bracket 3500 and the outer cover 3250. For example, the upper end coupling portion 3260 may close the second thermal insulation space G2. Accordingly, the effect of thermal insulation inside the heater assembly 3200 may be increased.

The bracket 3500 has a cylindrical shape in which the heater assembly 3200 is accommodated. The bracket 3500 may be spaced apart from an inner surface of the body 3100. A space between the inner surface of the body 3100 and the bracket 3500 may correspond to the third thermal insulation space G3.

As shown, the heater assembly 3200 is biased to one side (e.g., a right side) from the center of the bracket 3500. In addition, the bracket 3500 is also be biased to one side (e.g., a left side) from the center of the body 3100. However, the embodiment is not limited to the illustrated shape. The bracket 3500 is the same as that described with reference to FIG. 4, and thus, a repeated description will be omitted.

The thermal insulation unit 3700 may be coupled to an outer surface of the bracket 3500. Although the thermal insulation unit 3700 having a cylindrical shape is attached to the outer surface of the bracket 3500, the embodiment is not limited to the shape of the thermal insulation unit 3700. When the thermal insulation unit 3700 is coupled to the outer surface of the bracket 3500, a space between the inner surface of the body 3100 and the thermal insulation unit 3700 may correspond to the third thermal insulation space G3.

A position of the thermal insulation unit 3700 is not limited thereto. Although not shown, according to an embodiment, the thermal insulation unit 3700 may be coupled to an inner surface of the bracket 3500. Also, the thermal insulation unit 3700 may be coupled to an outer surface of the outer cover 3250 forming the exterior of the heater assembly 3200.

Although one thermal insulation unit 3700 is disposed inside the body 3100, the embodiment is not limited to the number of thermal insulation units 3700. The thermal insulation unit 3700 is the same as that described above, and thus, a repeated description will be omitted.

According to an aerosol generating device according to embodiments, because heat is blocked from being transferred to the outside of the aerosol generating device, a user's hand using the aerosol generating device may be protected from heat.

Also, according to the aerosol generating device according to embodiments, because heat is evenly dispersed by a thermal insulation unit, a specific portion of the aerosol generating device may be prevented from becoming excessively hot compared to other portions. Accordingly, a failure of internal components of the aerosol generating device may be prevented, and a phenomenon where a specific portion of a body becomes excessively hot may be prevented.

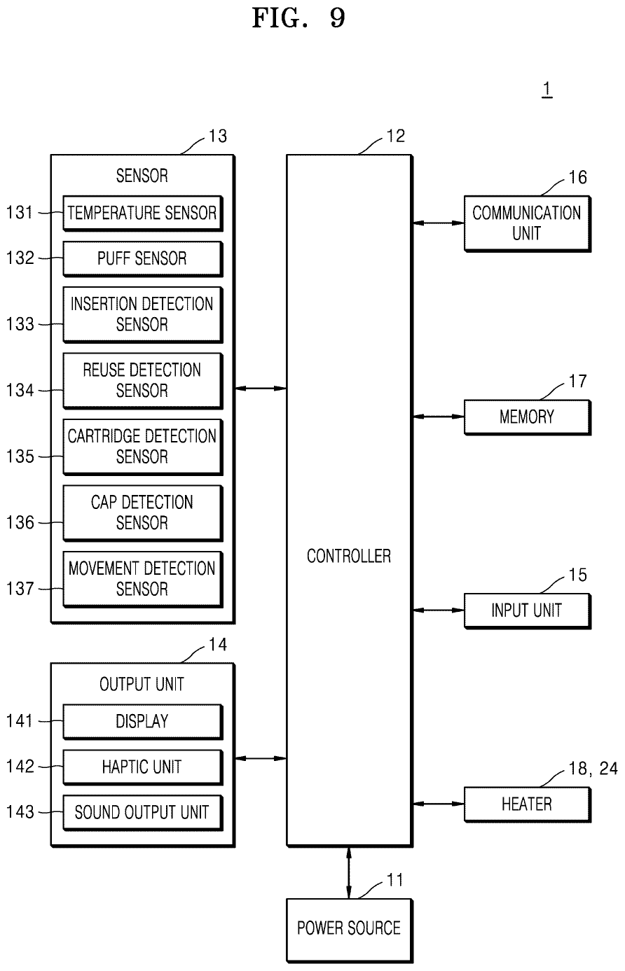

FIG. 9 is a block diagram of an aerosol generating device according to other embodiment of the present disclosure.

An aerosol generating device 1 may include a power source 11, a controller 12, a sensor 13, an output unit 14, an input unit 15, a communication unit 16, a memory 17, and one or more heaters 18 or 24. However, an internal structure of the aerosol generating device 1 is not limited to the illustration of FIG. 9. That is, it may be understood by those skilled in the art that some of the components shown in FIG. 9 may be omitted or new components may be added, according to the design of the aerosol generating device 1.

The sensor 13 may sense a state of the aerosol generating device 1 or a state of the surroundings of the aerosol generating device 1 and may transmit information corresponding to the sensed state to the controller 12. The controller 12 may control the aerosol generating device 1 so that various functions, such as operation control of the cartridge heater 24 and/or the heater 18, smoking restrictions, determination as to whether the stick S and/or the cartridge 19 is inserted, and an alarm display, may be performed, based on the information corresponding to the sensed state.

The sensor 13 may include at least one of a temperature sensor 131, a puff sensor 132, an insertion detection sensor 133, a reuse detection sensor 134, a cartridge detection sensor 135, a cap detection sensor 136, and a movement detection sensor 137.

The temperature sensor 131 may detect a temperature at which the cartridge heater 24 and/or the heater 18 is heated. The aerosol generating device 1 may include a separate temperature sensor for detecting the temperature of the cartridge heater 24 and/or the heater 18, or the cartridge heater 24 and/or the heater 18 may serve as a temperature sensor.

The temperature sensor 131 may output a signal corresponding to the cartridge heater 24 and/or the heater 18. For example, the temperature sensor 131 may include a resistor element of which resistance value changes according to a change in the temperature of the cartridge heater 24 and/or the heater 18. The temperature sensor 131 may be implemented by a thermistor, etc. which is an element using a property in which resistance changes according to a temperature. In this case, the temperature sensor 131 may output a signal corresponding to the resistance value of the resistor element as a signal corresponding to the temperature of the cartridge heater 24 and/or the heater 18. For example, the temperature sensor 131 may include a sensor for detecting the resistance value of the cartridge heater 24 and/or the heater 18. In this case, the temperature sensor 131 may output the signal corresponding to the resistance value of the cartridge heater 24 and/or the heater 18 as a signal corresponding to the temperature of the cartridge heater 24 and/or the heater 18.

The temperature sensor 131 may be disposed around the power source 11 to monitor a temperature of the power source 11. The temperature sensor 131 may be disposed adjacent to the power source 11. For example, the temperature sensor 131 may be attached to one surface of a battery, which is the power source 11. For example, the temperature sensor 131 may be mounted on one surface of a printed circuit board.

The temperature sensor 131 may be disposed inside the body 10 to detect an internal temperature of the body 10.

The puff sensor 132 may detect the user's puff, based on various physical changes in an airflow path. The puff sensor 132 may output a signal corresponding to the puff. For example, the puff sensor 132 may be a pressure sensor. The puff sensor 132 may output a signal corresponding to internal pressure of the aerosol generating device. The internal pressure of the aerosol generating device 1 may correspond to pressure of the airflow path on which gas flows. The puff sensor 132 may be disposed to correspond to the airflow path on which gas flows, in the aerosol generating device 1.

The insertion detection sensor 133 may detect insertion and/or removal of the stick S. The insertion detection sensor 133 may detect signal changes relating to insertion and/or removal of the stick S. The insertion detection sensor 133 may be installed around an insertion space. The insertion detection sensor 133 may detect insertion and/or removal of the stick S according to changes in dielectric constants inside the insertion space. For example, the insertion detection sensor 133 may be an inductive sensor and/or a capacitance sensor.

The inductive sensor may include at least one coil. The coil of the inductive sensor may be disposed adjacent to the insertion space. For example, when a magnetic field changes around a coil through which a current flows, the characteristics of the current flowing through the coil may be changed according to the Faraday's law. The characteristics of the current flowing through the coil may include a frequency of an alternating current, a current value, a voltage value, an inductance value, an impedance value, etc.

The inductive sensor may output signals corresponding to the characteristics of the current flowing through the coil. For example, the inductive sensor may output signals corresponding to the inductance value of the coil.

The capacitance sensor may include a conductor. The conductor of the capacitance sensor may be disposed adjacent to the insertion space. The capacitance sensor may output a signal corresponding to an electromagnetic characteristic of the surroundings, for example, an electrostatic capacitance around the conductor. For example, when the stick S including a wrapper made of a metal material is inserted into the insertion space, the electromagnetic properties around the conductor may be changed by the wrapper of the stick S.

The reuse detection sensor 134 may detect whether the stick S is reused. The reuse detection sensor 134 may be a color sensor. The color sensor may detect a color of the stick S. The color sensor may detect a color of a portion of the wrapper surrounding the outside of the stick S. The color sensor may detect values for optical characteristics corresponding to the color of an object, based on light reflected by the object. For example, the optical characteristics may be a wavelength of the light. The color sensor may be implemented as a single component with the proximity sensor, or may be implemented as a separate component distinct from the proximity sensor.

A color of at least a portion of the wrapper that constitutes the stick S may be changed by aerosol. In case where the stick S is inserted into the insertion space, the reuse detection sensor 134 may be disposed to correspond to a location in which at least a portion of the wrapper of which color is changed by aerosol. For example, before the stick S is used by the user, the color of at least the portion of the wrapper may be a first color. In this case, as at least a portion of the wrapper is wet by aerosol generated by the aerosol generating device 1 while the aerosol is passing through the stick S, the color of the at least a portion of the wrapper may be changed to a second color. The color of the at least a portion of the wrapper may be maintained as the second color after being changed from the first color to the second color.

The cartridge detection sensor 135 may detect insertion and/or removal of the cartridge 19. The cartridge detection sensor 135 may be implemented by an inductance-based sensor, a capacitive sensor, a resistance sensor, a hall sensor (hall IC) using a hall effect, etc.

The cap detection sensor 136 may detect mounting and/or removal of a cap. When the cap is separated from the body 10, a portion of the cartridge 19 and the body 10 covered by the cap may be exposed to the outside. The cap detection sensor 136 may be implemented by a contact sensor, a hall sensor (hall IC), an optical sensor, etc.

The movement detection sensor 137 may detect a movement of the aerosol generating device. The movement detection sensor 137 may be implemented with at least one of an acceleration sensor and a gyro sensor.

The sensor 13 may further include at least one of a humidity sensor, a barometric pressure sensor, a magnetic sensor, a global positioning sensor (GPS), and a proximity sensor, in addition to the above-described sensors 131 through 137. Functions of the sensors would be instinctively understood by one of ordinary skill in the art in view of their names and thus detailed descriptions thereof will be omitted herein.

The output unit (output interface) 14 may output information about the state of the aerosol generating device 1 and may provide the information to the user. The output unit 14 may include at least one of a display 141, a haptic unit 142, and a sound output unit 143, but embodiments are not limited thereto. When the display 141 forms a layer structure together with a touch pad to construct a touch screen, the display 141 may be used as an input device as well as an output device.

The display 141 may visually provide information about the aerosol generating device 1 to the user. For example, the information about the aerosol generating device 1 may refer to various pieces of information, such as the charging/discharging state of the power source 11 of the aerosol generating device 1, a preheating state of the heater 18, an insertion/removal state of the stick S and/or the cartridge 19, a mounting/removal state of the cap, or a state in which use of the aerosol generating device 1 is limited (e.g., detection of an abnormal article), and the display 141 may output the information to the outside. For example, the display 141 may have a shape of a light-emitting diode (LED). For example, the display 141 may be a liquid crystal display (LCD), an organic light-emitting display (OLED) panel, or the like.

The haptic unit 142 may convert an electrical signal into a mechanical stimulus or electrical stimulus and may tactually provide information about the aerosol generating device 1 to the user. For example, when initial power is supplied to the cartridge heater 24 and/or the heater 18 for a set time, the haptic unit 142 may generate vibration corresponding to completion of initial preheating. The haptic unit 142 may include a motor, a piezoelectric element, and/or an electrical stimulation device.

The sound output unit 143 may acoustically provide the information about the aerosol generating device 1 to the user. For example, the sound output unit 143 may convert the electrical signal into a sound signal and may output the sound signal to the outside.

The power source (power supply) 11 may supply power used to operate the aerosol generating device 1. The power source 11 may supply power so that the cartridge heater 24 and/or the heater 18 may be heated. In addition, the power source 11 may supply power required for operations of the sensor 13, the output unit 14, the input unit 15, the communication unit 16, and the memory 17, which are other components provided in the aerosol generating device 1. The power source 11 may be a rechargeable battery or a disposable battery. For example, the power source 11 may be a lithium polymer (LiPoly) battery, but embodiments are not limited thereto.

Although not shown in FIG. 9, the aerosol generating device 1 may further include a power supply protection circuit. The power supply protection circuit may be electrically connected to the power source 11 and may include a switching element.

The power supply protection circuit may cut off an electric path for the power source 11 according to certain conditions. For example, when a voltage level of the power source 11 is greater than or equal to a first voltage corresponding to overcharging, the power supply protection circuit may cut off the electric path for the power source 11. For example, when a voltage level of the power source 11 is less than a second voltage corresponding to overdischarging, the power supply protection circuit may cut off the electric path for the power source 11.

The heater 18 may heat a medium or an aerosol generating material in the stick S by receiving power from the power source 11. Although not shown in FIG. 9, the aerosol generating device 1 may further include a power conversion circuit (e.g., a DC/DC converter) for converting power of the power source 11 to supply the converted power to the cartridge heater 24 and/or the heater 18. In addition, when the aerosol generating device 1 generates aerosol by using an induction heating method, the aerosol generating device 1 may further include a DC/AC converter that converts direct current power of the power source 11 into alternating current power.

The controller 12, the sensor 13, the output unit 14, the input unit 15, the communication unit 16, and the memory 17 may perform functions by receiving power from the power source 11. Although not shown in FIG. 9, the aerosol generating device 1 may further include a power conversion circuit for converting the power of the power source 11 to supply the converted power to components, for example, a low dropout (LDO) circuit or a voltage regulator circuit. Although not shown in FIG. 9, a noise filter may be provided between the power source 11 and the heater 18. The noise filter may be a low pass filter. The low pass filter may include at least one inductor and a capacitor. A cutoff frequency of the low pass filter may correspond to a frequency of a radio frequency switching current applied from the power source 11 to the heater 18. Radio frequency noise components may be prevented from being applied to the sensor 13, such as the insertion detection sensor 133, by the low pass filter.

According to an embodiment, the cartridge heater 24 and/or the heater 18 may be formed of an arbitrary proper electric resistance material. For example, the proper electric resistance material may be metal or metal alloy including titanium, zirconium, tantalum, platinum, nickel, cobalt, chromium, hafnium, niobium, molybdenum, tungsten, tin, gallium, manganese, iron, copper, stainless steel, nichrome, etc., but embodiments are not limited thereto. Also, the heater 18 may be implemented using a metal heating wire, a metal heating plate on which an electric conductive track is disposed, a ceramic heating body, or the like, but embodiments are not limited thereto.

According to another embodiment, the heater 18 may be a heater using an induction heating method. For example, the heater 18 may include a susceptor that generates heat by a magnetic field applied by the coil and heats the aerosol generating material.

The input unit (input interface) 15 may receive information input from the user or may output the information to the user. For example, the input unit 15 may be a touch panel. The touch panel may include at least one touch sensor that detects touch. For example, the touch sensor may include a capacitive touch sensor, a resistive touch sensor, a surface acoustic wave touch sensor, an infrared touch sensor, or the like, but embodiments are not limited thereto.

The display 141 and the touch panel may be implemented as one panel. For example, the touch panel may be inserted (on-cell type or in-cell type) into the display 141. For example, the touch panel may be added on (add-on type) the display panel.

The input unit 15 may include a button, a key pad, a dome switch, a jog wheel, a jog switch, or the like, but embodiments are not limited thereto.

The memory 17 is hardware for storing various kinds of data processed in the aerosol generating device 1, and may store pieces of data that have been processed and are to be processed by the controller 12. The memory 17 may include at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk. The memory 17 may store data about the operating time of the aerosol generating device 1, a maximum number of puffs, a current number of puffs, at least one temperature profile, and the user's smoking pattern.

The communication unit (communication interface, communicator) 16 may include at least one component for communication with other electronic devices. For example, the communication unit 16 may include at least one of a short-range wireless communication unit and a wireless communication unit.

Examples of the short-range wireless communication unit may include, but are not limited to, a Bluetooth communication unit, a Bluetooth Low Energy (BLE) communication unit, a near field communication (NFC) unit, a wireless local area network (WLAN) (e.g., Wi-Fi) communication unit, a ZigBee communication unit, an infrared Data Association (IrDA) communication unit, a Wi-Fi direct (WFD) communication unit, an ultra wideband (UWB) communication unit, and an Ant+ communication unit.

The wireless communication unit may include a cellular network communication unit, an Internet communication unit, a computer network (e.g., a LAN or a WAN) communication unit, or the like, but embodiments are not limited thereto.

Although not shown in FIG. 9, the aerosol generating device 1 may further include a connection interface, such as a universal serial bus (USB) interface, and may transmit/receive information by being connected to another external device through the connection interface, such as a USB interface, or may charge the power source 11.

The controller 12 may control overall operations of the aerosol generating device 1. According to an embodiment, the controller 12 may include at least one processor. The processor may be implemented by an array of a plurality of logic gates, or may be implemented by a combination of a general-use microprocessor and a memory in which a program executable by the general-use microprocessor is stored. It will also be understood by one of ordinary skill in the art to which the present embodiment pertains that the processor may be implemented by other types of hardware.

The controller 12 may control supplying of the power of the power source 11 to the heater 18, thereby controlling the temperature of the heater 18. The controller 12 may control the temperature of the cartridge heater 24 and/or the heater 18, based on the temperature of the cartridge heater 24 and/or the heater 18 sensed by the temperature sensor 131. The controller 12 may control power supplied to the cartridge heater 24 and/or the heater 18, based on the temperature of the cartridge heater 24 and/or the heater 18. For example, the controller 12 may determine a target temperature of the cartridge heater 24 and/or the heater 18, based on a temperature profile stored in the memory 17.

The aerosol generating device 1 may include a power supply circuit (not shown) electrically connected to the power source 11 between the power source 11 and the cartridge heater 24 and/or the heater 18. The power supply circuit may be electrically connected to the cartridge heater 24, the heater 18, or an induction coil 181. The power supply circuit may include at least one switching element. The switching element may be implemented by a bipolar junction transistor (BJT), a field effect transistor (FET), or the like. The controller 12 may control the power supply circuit.

The controller 12 may control switching of the switching element of the power supply circuit, thereby controlling the supply of power. The power supply circuit may be an inverter that converts direct current power output by the power source 11 into alternating current power. For example, the inverter may include a full-bridge circuit or half-bridge circuit including a plurality of switching elements.

The controller 12 may turn on the switching element so that power may be supplied from the power source 11 to the cartridge heater 24 and/or the heater 18. The controller 12 may turn off the switching element so that the supply of power to the cartridge heater 24 and/or the heater 18 may be cut off. The controller 12 may adjust a current supplied by the power source 11 by adjusting a frequency and/or duty ratio of a current pulse input to the switching element.

The controller 12 may control a voltage output by the power source 11 by controlling switching of the switching element of the power supply circuit. The power conversion circuit may convert the voltage output by the power source 11. For example, the power conversion circuit may include a Buck-converter that drops the voltage output by the power source 11. For example, the power conversion circuit may be implemented through a Buck-boost converter, a Zener diode, etc.

The controller 12 may adjust the level of the voltage output by the power conversion circuit by controlling an on/off operation of the switching element included in the power conversion circuit. When an on state of the switching element is continued, the level of the voltage output by the power conversion circuit may correspond to the level of the voltage output by the power source 11. A duty ratio with respect to the on/off operation of the switching element may correspond to a ratio of the voltage output by the power conversion circuit to the voltage output by the power source 11. As the duty ratio with respect to the on/off operation of the switching element is decreased, the level of the voltage output by the power conversion circuit may be reduced. The heater 18 may be heated based on the voltage output by the power conversion circuit.

The controller 12 may control power to be supplied to the heater 18, by using at least one method of a pulse width modulation (PWM) method and a proportional-integral-differential (PID) method.

For example, the controller 12 may control supply of a current pulse having a certain frequency and a duty ratio, by using the PWM method. The controller 12 may control power supplied to the heater 18 by adjusting the frequency and duty ratio of the current pulse.

For example, the controller 12 may determine a target temperature that is a target of control, based on the temperature profile. The controller 12 may control the power supplied to the heater 18 by using a PID method, which is a feedback control method using a difference value between the temperature of the heater 18 and the target temperature thereof, a value obtained by integrating the difference value according to the flow of time, and a value obtained by differentiating the difference value according to the flow of time.

The controller 12 may prevent the cartridge heater 24 and/or the heater 18 from being overheated. For example, the controller 12 may control an operation of the power conversion circuit so that the supply of the power to the cartridge heater 24 and/or the heater 18 is stopped, based on the temperature of the cartridge heater 24 and/or the heater 18 exceeding a preset limit temperature. For example, the controller 12 may reduce the amount of power supplied to the cartridge heater 24 and/or the heater 18, based on the temperature of the cartridge heater 24 and/or the heater 18 exceeding the preset limit temperature. For example, the controller 12 may determine that the aerosol generating material accommodated in the cartridge 19 is exhausted, based on the temperature of the cartridge heater 24 exceeding the limit temperature, and may cut off the supply of power to the cartridge heater 24.

The controller 12 may control charging/discharging of the power source 11. The controller 12 may check the temperature of the power source 11, based on an output signal of the temperature sensor 131.

When a power wire is connected to a battery terminal of the aerosol generating device 1, the controller 12 may check whether the temperature of the power source 11 is greater than or equal to a first limit temperature that is a basis for blocking charging of the power source 11. When the temperature of the power source 11 is less than the first limit temperature, the controller 12 may control the power source 11 to be charged, based on a preset charging current. When the temperature of the power source 11 is equal to or greater than the first limit temperature, the controller 12 may block charging of the power source 11.

When power of the aerosol generating device 1 is in an on state, the controller 12 may check whether the temperature of the power source 11 is greater than or equal to a second limit temperature that is a basis for cutting off discharging of the power source 11. When the temperature of the power source 11 is less than the second limit temperature, the controller 12 may control the power stored in the power source 11 to be used. When the temperature of the power source 11 is greater than or equal to the second limit temperature, the controller 12 may stop using the power stored in the power source 11.

The controller 12 may calculate the remaining capacity of the power stored in the power source 11. For example, the controller 12 may calculate the remaining capacity of the power source 11, based on a voltage and/or current sensing value of the power source 11.

The controller 12 may determine whether the stick S is inserted into the insertion space, through the insertion detection sensor 133. The controller 12 may determine that the stick S is inserted, based on an output signal of the insertion detection sensor 133. When it is determined that the stick S is inserted into the insertion space, the controller 12 may control power to be supplied to the cartridge heater 24 and/or the heater 18. For example, the controller 12 may supply power to the cartridge heater 24 and/or the heater 18, based on the temperature profile stored in the memory 17.

The controller 12 may determine whether the stick S is removed from the insertion space. For example, the controller 12 may determine whether the stick S is removed from the insertion space, through the insertion detection sensor 133. For example, when the temperature of the heater 18 is greater than or equal to the limit temperature or when a temperature change slope of the heater 18 is equal to or greater than a set slope, the controller 12 may determine that the stick S is removed from the insertion space. When it is determined that the stick S has been removed from the insertion space, the controller 12 may block supply of power to the cartridge heater 24 and/or the heater 18.

The controller 12 may control a power supply time and/or a power supply amount for the heater 18 according to the state of the stick S detected by the sensor 13. The controller 12 may check a level range in which the level of a signal of a capacitance sensor is included, based on a lookup table. The controller 12 may check a moisture amount for the stick S according to the checked level range.

When the stick S is in an overwatering state, the controller 12 may control the power supply time for the heater 18 to thereby increase the preheating time of the stick S rather than when the stick S is in a general state.

The controller 12 may determine whether the stick S inserted into the insertion space is reused, through the reuse detection sensor 134. For example, the controller 12 may compare a sensing value of a signal of the reuse detection sensor with a first reference range in which a first color is included, and may determine that the stick S is not used when the sensing value is included in the first reference range. For example, the controller 12 may compare the sensing value of the signal of the reuse detection sensor with a second reference range in which a second color is included, and may determine that the stick S is used when the sensing value is included in the second reference range. When it is determined that the stick S is used, the controller 12 may block supply of power to the cartridge heater 24 and/or the heater 18.

The controller 12 may determine whether the cartridge 19 is combined and/or removed, through the cartridge detection sensor 135. For example, the controller 12 may determine whether the cartridge 19 is combined or removed, based on the sensing value of a signal of the cartridge detection sensor.

The controller 12 may determine whether the aerosol generating material of the cartridge 19 is exhausted. For example, the controller 12 may preheat the cartridge heater 24 and/or the heater 18 by applying power, may determine whether the temperature of the cartridge heater 24 exceeds the limit temperature in a preheating section, and, when the temperature of the cartridge heater 24 exceeds the limit temperature, may determine that the aerosol generating material of the cartridge 19 is exhausted. When it is determined that the aerosol generating material of the cartridge 19 is exhausted, the controller 12 may cut off the supply of power to the cartridge heater 24 and/or the heater 18.

The controller 12 may determine whether use of the cartridge 19 is possible. For example, the controller 12 may determine that the use of the cartridge 19 is not possible if a current puff frequency is greater than or equal to a maximum puff frequency set in the cartridge 19, based on data stored in the memory 17. For example, when a total time period during which the heater 24 is heated is greater than or equal to a preset maximum time period or a total amount of power supplied to the cartridge heater 24 is greater than or equal to a preset maximum power amount, the controller 12 may determine that the use of the cartridge 19 is not possible.

The controller 12 may perform determination on the user's inhaling through the puff sensor 132. For example, the controller 12 may determine whether a puff occurs, based on a sensing value of a signal of the puff sensor. For example, the controller 12 may determine the intensity of the puff, based on the sensing value of the signal of the puff sensor 132. When the puff frequency reaches the preset maximum puff frequency or puffs are not sensed for a preset time period or more, the controller 12 may cut off the supply of power to the cartridge heater 24 and/or the heater 18.

The controller 12 may determine whether the cap is combined and/or removed, through the cap detection sensor 136. For example, the controller 12 may determine whether the cap is combined or removed, based on a sensing value of a signal of the cartridge detection sensor.

The controller 12 may control the output unit 14, based on a result of the sensing performed by the sensor 13 For example, when the number of puffs counted by the puff sensor 132 reaches a preset number, the controller 12 may notify the user in advance that the aerosol generating device 1 is ended soon, through at least one of the display 141, the haptic unit 142, and the sound output unit 143. For example, the controller 12 may notify the user through the output unit 14, based on a determination that the stick S is not present in the insertion space. For example, the controller 12 may notify the user through the output unit 14, based on a determination that the cartridge 19 and/or the cap is not mounted. For example, the controller 12 may transmit information about the temperature of the cartridge heater 24 and/or the heater 18 to the user through the output unit 14.

The controller 12 may store and update a history of an event occurred in the memory 17, based on certain event occurrence. The event may include insertion detection of the stick S, heating start of the stick S, puff detection, puff end, overheat detection of the cartridge heater 24 and/or the heater 18, detection of overvoltage application to the cartridge heater 24 and/or the heater 18, heating end of the stick S, an operation such as power on/off of the aerosol generating device 1, charging start of the power source 11, detection of overcharging of the power source 11, and charging end of the power source 11, which are performed by the aerosol generating device 1. The history of the event may include, for example, a date and time of the event, log data corresponding to the event. For example, when a predetermined event is insertion detection of the stick S, log data corresponding to the event may include data for the sensing value, etc. of the insertion detection sensor 133. For example, when the predetermined event is overheating detection of the cartridge heater 24 and/or the heater 18, the log data corresponding to the event may include data about, for example, the temperature of the cartridge heater 24 and/or heater 18, the voltage applied to the cartridge heater 24 and/or the heater 18, and a current flowing through the cartridge heater 24 and/or the heater 18.

The controller 12 may control a communication link to be formed with an external device, such as the user's mobile terminal. When receiving data on authentication from an external device through the communication link, the controller 12 may remove limitation of the use of at least one function of the aerosol generating device 1. The data on authentication may include data indicating completion of user authentication with respect to a user corresponding to the external device. The user may perform user authentication through the external device. The external device may determine whether user data is valid, based on the user's birthday and a unique number representing the user, and may receive data about use authority of the aerosol generating device 1 from an external server. The external device may transmit data indicating the completion of the user authentication to the aerosol generating device 1, based on the data about the use authority. When the user authentication is completed, the controller 12 may remove limitation of the use of the at least one function of the aerosol generating device 1. For example, when the user authentication is completed, the controller 12 may remove the limitation of the use of a heating function of supplying power to the heater 18.

The controller 12 may transmit data on the state of the aerosol generating device 1 to the external device through the communication link formed with the external device. Based on the received state data, the external device may output the remaining capacity, the operation mode, etc. of the power source 11 of the aerosol generating device 1 through a display of the external device.

The external device may transmit a position search request to the aerosol generating device 1, based on an input of starting a position search of the aerosol generating device 1. When receiving a position search request from the external device, the controller 12 may control at least one of output devices to perform an operation corresponding to a position search, based on the received position search request. For example, the haptic unit 142 may generate vibration in response to the position search request. For example, in response to the position search request, the display 141 may output an object that corresponds to position search and search end.

The controller 12 may control firmware update to be performed, when receiving firmware data from the external device. The external device may check a current version of the firmware of the aerosol generating device 1 and determine whether a new version of the firmware is present. When receiving an input of requesting for firmware download, the external device may receive the new version of the firmware data and transmit the new version of the firmware data to the aerosol generating device 1. As the controller 12 receives the new version of the firmware data, the controller 12 may control the firmware update of the aerosol generating device 1 to be performed.

The controller 12 may transmit data on a sensing value of the at least one sensor 13 to an external server (not shown) through the communication unit 16, and may receive and store a learning model generated by learning sensing values from a server through machine learning, such as deep learning. The controller 12 may perform, for example, an operation of determining the user's inhaling pattern and an operation of generating a temperature profile, by using the learning model received from the server. The controller 12 may store, for example, sensing value data of the at least one sensor 13 and data for training an artificial neural network (ANN) in the memory 17. For example, the memory 17 may store a database for each component provided in the aerosol generating device 1, a weight that forms an ANN structure, and biases, which are for training the ANN. The controller 12 may learn data on a sensing value of at least one sensor 13, the user's inhaling pattern, the temperature profile, etc. stored in the memory 17, and may generate at least one learning model used for, for example, determination of the user's inhaling pattern, generation of the temperature profile.

Certain embodiments or other embodiments of the present disclosure described above are not exclusive or distinct from each other. The certain embodiments or other embodiments of the present disclosure described above may be combined with each other or used in combination with each other in their respective components or functions.

For example, it means that an A component described in a specific embodiment and/or the drawings and a B component described in another embodiment and/or the drawings may be combined with each other. In other words, even when it is not explained directly about combination between components, it is possible to combine unless it is explained that combination is impossible.

The above detailed description should not be interpreted restrictedly but should be considered illustrative in all aspects. The scope of the present disclosure should be determined by a rational interpretation of the attached claims, and all changes within the equivalent scope of the present disclosure are included in the scope of the present disclosure.

According to an aerosol generating device according to embodiments, because heat is blocked from being transferred to the outside of the aerosol generating device, a user's hand using the aerosol generating device may be protected from heat.

Also, according to the aerosol generating device according to embodiments, a specific portion of the aerosol generating device may be prevented from becoming excessively hot compared to other portions.

Effects of the present disclosure are not limited to the above effects, and effects that are not mentioned could be clearly understood by one of ordinary skill in the art from the present specification and the attached drawings.

What is claimed is:

1. An aerosol generating device comprising:
a body comprising an insertion space in which an aerosol generating article is accommodated;
a heater configured to heat the aerosol generating article accommodated in the insertion space by generating heat;
a first thermal insulation unit surrounding at least a portion of the heater and configured to block heat generated from the heater from being transferred to a user; and
a bracket spaced apart from the heater and supporting the first thermal insulation unit,
wherein the first thermal insulation unit comprises a first heat-conducting layer configured to disperse, through heat conduction, heat absorbed from the heater, and a first heat-blocking layer configured to block heat transferred to the first heat-conducting layer from being transferred to outside so that the heat transferred to the first heat-conducting layer remains in the first heat-conducting layer.

2. The aerosol generating device of claim 1, wherein the first heat-conducting layer and the heat-blocking layer are in contact with each other and are sequentially arranged in a direction from inside to outside of the body.

3. The aerosol generating device of claim 1, wherein the first thermal insulation unit is spaced apart from an inner surface of the body.

4. The aerosol generating device of claim 1, wherein
the first heat-blocking layer comprises a first area and a second area separated from each other and facing each other, and
the first heat-conducting layer is disposed inside the second area of the first heat-blocking layer.

5. The aerosol generating device of claim 1, further comprising a second thermal insulation unit disposed outside the first thermal insulation unit,
wherein the second thermal insulation unit comprises a second heat-conducting layer configured to absorb heat and spread the heat to a whole surface through heat conduction, and a second heat-blocking layer configured to block heat transferred to the second heat-conducting layer from being transferred to outside so that the heat transferred to the second heat-conducting layer remains in the second heat-conducting layer.

6. The aerosol generating device of claim 5, wherein the first heat-conducting layer, the first heat-blocking layer, the second heat-conducting layer, and the second heat-blocking layer are sequentially arranged in contact with each other in a direction from inside to outside of the body.

7. The aerosol generating device of claim 6, further comprising a third thermal insulation unit disposed outside the second thermal insulation unit,
wherein the first thermal insulation unit, the second thermal insulation unit, and the third thermal insulation unit are sequentially arranged in contact with each other in a direction from the inside to the outside of the body.

8. The aerosol generating device of claim 5, wherein the second thermal insulation unit is spaced apart from an inner surface of the body.

9. The aerosol generating device of claim 1, further comprising a first cover surrounding the heater at a certain distance from the heater and accommodating at least a portion of the heater therein,
wherein the bracket is spaced apart from the first cover.

10. The aerosol generating device of claim 9, wherein one or more grooves are formed in an outer surface of the first cover.

11. The aerosol generating device of claim 9, further comprising a second cover surrounding the first cover and spaced apart from an outer surface of the first cover,
wherein the bracket is spaced apart from the second cover.

12. The aerosol generating device of claim 11, wherein the second cover comprises an inner wall facing the first cover, an outer wall at least partially spaced apart from the inner wall, and a thermal insulation space formed between the inner wall and the outer wall.

13. The aerosol generating device of claim 11, further comprising an airflow passage portion disposed on an inner surface of the first cover and supported by the first cover.

14. The aerosol generating device of claim 1, wherein the bracket comprises a first member having a cylindrical shape surrounding the heater, and a second member coupled to a side portion of the first member and one end of the first member to block an open end of the first member,
wherein one or more grooves are formed in an outer surface of the first member.

15. The aerosol generating device of claim 1, wherein the bracket comprises a first extension portion surrounding the heater, a second extension portion surrounding the first extension portion, and a connection portion connecting the first extension portion to the second extension portion,
wherein the first thermal insulation unit is disposed between the first extension portion and the second extension portion.
